(19) United States
(12) Patent Application Publication
(10) Pub. No.: US 2024/0092687 A1
(43) Pub. Date: Mar. 21, 2024

(54) GLASS-CERAMIC HAVING SPECIFIC THERMAL EXPANSION CHARACTERISTICS

(71) Applicant: Schott AG, Mainz (DE)

(72) Inventors: Ina Mitra, Mainz (DE); Sonja Lauer, Mainz (DE); Clemens Kunisch, Mainz (DE); Christoph Gross, Mainz (DE)

(73) Assignee: Schott AG, Mainz (DE)

(21) Appl. No.: 18/468,128

(22) Filed: Sep. 15, 2023

(30) Foreign Application Priority Data
Sep. 15, 2022 (DE) 10 2022 123 616.1

(51) Int. Cl. C03C 10/00

(52) U.S. Cl. CPC C03C 10/0027

(57) ABSTRACT

A lithium aluminum silicate (LAS) glass-ceramic has an average coefficient of thermal expansion (CTE) in a range from 0 to 50° C. of at most 0±0.1×10⁻⁶/K and a thermal hysteresis at least in a temperature range from 15° C. to 35° C. of <0.1 ppm. The LAS glass-ceramic includes (in mol % based on oxide): SiO₂ 60-<70; Li₂O 7-9.6; MgO+ZnO>0.5-1.5; R₂O>0.5, where R₂O is Na₂O and/or K₂O and/or Cs₂O and/or Rb₂O; and nucleating agent with a content of 1.5 to 6 mol %. The nucleating agent is at least one component selected from the group consisting of TiO₂, ZrO₂, Ta₂O₅, Nb₂O₅, SnO₂, MoO₃, WO₃ and HfO₂.

### CROSS REFERENCE TO RELATED APPLICATIONS

The present application claims priority to German Patent Application No. 10 2022 123 616.1 filed on Sep. 15, 2022, which is incorporated in its entirety herein by reference.

### BACKGROUND OF THE INVENTION

### 1. Field of the Invention

The present invention relates to a glass-ceramic having specific thermal expansion characteristics and simultaneously good meltability, shaping and ceramizability, and to the use of the glass-ceramic in a precision component, more particularly in a precision component in lithography, especially in EUV lithography.

### 2. Description of the Related Art

Materials and precision components having low thermal expansion or low CTE (coefficient of thermal expansion) are already known in the prior art.

Known materials for precision components having low thermal expansion in the temperature range around room temperature are ceramics, Ti-doped quartz glass and glass-ceramics. Glass-ceramics having low thermal expansion are, in particular, lithium aluminium silicate glass-ceramics (LAS glass-ceramics), which are described, for example, in U.S. Pat. Nos. 4,851,372, 5,591,682, EP 587979 A, U.S. Pat. Nos. 7,226,881, 7,645,714, DE 102004008824 A and DE 102018111144 A. Further materials for precision components are cordierite ceramics or cordierite glass-ceramics.

Such materials are frequently used for precision components that have to meet particularly exacting requirements in terms of their properties (e.g. mechanical, physical, optical properties). They are employed in particular in terrestrial and space-based astronomy and Earth observation, LCD lithography, microlithography and EUV lithography, metrology, spectroscopy and measurement technology. In this context it is necessary for the components, according to specific application, to have in particular an extremely low thermal expansion.

In general, the thermal expansion of a material is determined by a static method in which the length of a test specimen is determined at the start and at the end of the specific temperature interval, and the difference in length is used to calculate the average coefficient of expansion a or CTE (coefficient of thermal expansion). The CTE is then reported as the average for this temperature interval—for example, for the temperature interval from 0° C. to 50° C., as CTE(0;50) or a(0;50).

In order to satisfy the constantly rising requirements, materials have been developed that have a CTE better matched to the field of use of a component formed from the material. For example, the average CTE can be optimized not only for the standard temperature interval CTE(0;50) but also, for example, for a temperature interval around the actual application temperature, for example the interval from 19° C. to 25° C., i.e. CTE(19;25), for particular lithography applications. As well as the determination of the average CTE, it is possible to determine the thermal expansion of a test specimen in very small temperature intervals as well and hence to represent it as a CTE-T curve. A CTE-T curve of this kind may optionally have a zero crossing at one or more temperatures, preferably at or close to the planned application temperature. At a zero crossing of the CTE-T curve, the relative change in length with change in temperature is particularly small. For certain glass-ceramics, such a zero crossing of the CTE-T curve may be shifted to the application temperature of the component by suitable temperature treatment. As well as the absolute CTE value, the slope of the CTE-T curve should also be at a minimum around the application temperature in order to bring about a minimum change in length of the component in the event of slight temperature changes. The above-described optimizations of the CTE or of the thermal expansion take place, in the case of these specific zero-expansion glass-ceramics, generally for constant composition by variation of the ceramization conditions.

An adverse effect in the case of the known precision components and materials, especially in the case of the glass-ceramics such as LAS glass-ceramics, is “thermal hysteresis”, called “hysteresis” hereinafter for short. Hysteresis here means that the change in length of a test specimen on heating at constant heating rate differs from the change in length of the test specimen on subsequent cooling at constant cooling rate, even if the magnitude of cooling rate and heating rate is the same. If the change in length is presented as a graph as a function of the temperature for heating or cooling, a classic hysteresis loop is the result. The extent of the hysteresis loop depends here also on the rate of the temperature change. The faster the change in temperature, the more marked the hysteresis effect. The hysteresis effect makes it clear that the thermal expansion of an LAS glass-ceramic is dependent on the temperature and on the time, i.e., for example, on the rate of temperature change, and this has also already been described occasionally in the specialist literature, e.g. O. Lindig and W. Pannhorst, “Thermal expansion and length stability of ZERODUR® in dependence on temperature and time”, APPLIED OPTICS, Vol. 24, No. 20, Oct. 1985; R. Haug et al., “Length variation in ZERODUR® M in the temperature range from −60° C. to +100° C.”, APPLIED OPTICS, Vol. 28, No. 19, Oct. 1989; R. Jedamzik et al., “Modeling of the thermal expansion behavior of ZERODUR® at arbitrary temperature profiles”, Proc. SPIE Vol. 7739, 2010; D. B. Hall, “Dimensional stability tests over time and temperature for several low-expansion glass ceramics”, APPLIED OPTICS, Vol. 35, No. 10, April 1996.

Since the change in length of a glass-ceramic exhibiting thermal hysteresis is delayed or advanced with respect to the change in temperature, the material or a precision component manufactured therefrom exhibits a disruptive isothermal change in length, meaning that, after a change in temperature, a change in length of the material occurs even at the time when the temperature is already being held constant (so-called “isothermal hold”), specifically until a stable state is attained. If the material is subsequently again heated and cooled, the same effect occurs again.

With the LAS glass-ceramics known to date, in spite of variation of the ceramization conditions with consistent composition, it has not been possible to date to eliminate the thermal hysteresis effect without adversely affecting other properties.

In relation to the properties of materials, especially glass-ceramics, for use in precision components, a relevant temperature range is frequently from 0° C. to 50° C., especially from 10° C. to 35° C. or from 19° C. to 25° C., with a temperature of 22° C. being generally referred to as room temperature. Glass-ceramics are employed, for example, for precision components in lithography, especially in EUV lithography.

EUV lithography (also called EUVL hereinafter) is a photolithography process which utilizes electromagnetic radiation between typically 5 nm and 50 nm (soft x-rays), especially electromagnetic radiation having a wavelength of 13.5 nm (91.82 eV). This radiation is referred to as “extreme ultraviolet radiation” (EUV). This range of the electromagnetic spectrum is absorbed completely by virtuely all materials. Consequently, in contrast to DUV lithography (Deep ultraviolet, for example 248 nm and/or 193 nm), it is not possible to use optically transparent photomasks (also referred to hereinafter as reticles, reticle masks or masks), it being necessary instead to use reflective multi-layer stack systems on a photomask substrate with low thermal expansion (also referred to below as reticle substrate, mask substrate, reticle mask blank, photomask blank or mask blank or substrate) as photomasks. A disadvantage of using reflective photomasks, however, is the comparatively poor maximum reflectivity of the multi-layer stack in the EUV radiation range, of typically less than 70%. The radiation which the photomask does not reflect is absorbed thereby and transmitted in the form of heat to the photomask substrate and also, possibly, to the photomask carrier (also referred to below as reticle carrier or reticle stage or mask carrier or mask stage or photomask stage), thereby possibly increasing the temperature of these components, especially as the irradiation time increases.

Even slight thermally induced deformations of the photomask, however, can lead to imaging errors on the illuminated wafer and hence to yield losses during chip production. To prevent the described local deformations and distortions in the photomask substrate, it is therefore necessary, for photomask substrates, to use materials with low thermal expansion or a low CTE (coefficient of thermal expansion).

This is all the more important given that the average power of the EUV beam sources used in EUV lithography will increase in future in order to boost the throughput, for example via higher repetition rates and/or higher individual pulse energies, and, consequently, the thermal load on the photomask and possibly also on the photomask carrier will increase. As a result, active cooling concepts for the photomask and for the photomask carrier will become increasingly significant, possibly leading to further temperature changes especially in the photomask and the photomask carrier. In this context, it must also be borne in mind that the thermal load on the photomasks and/or on the photomask carrier is not constant, but instead fluctuates as a result of various factors. These factors include temporally non-uniform illumination times, resulting, for example, from the loading of the photomask carrier with a new photomask or from downtimes due to faltering operations. The stated thermally induced deformations can be compensated partly through compensation mechanisms within the overall optical system of a lithography unit, in the beam shaping of the illumination, for example; this compensation, however, is limited, and hence it is advantageous to minimize the individual contributions to (imaging) errors. Account must be taken here not only of thermally induced deformation of the material during illumination, but also of the thermal characteristics over time (thermal hysteresis). Materials having a comparatively high thermal hysteresis, however, make the aforesaid compensation more difficult and hence also make it more difficult to prevent unwanted thermal imaging errors by the photomask.

Further EUVL precision components with exacting requirements in terms of their thermal properties are, in particular, also EUVL mirrors in the optical system of the EUVL device, and wafer carriers (also referred to below as wafer stages), on which the (Si) wafers for exposure are placed.

Given that many applications of precision components, particularly applications in EUV lithography, take place in the temperature range from greater than 0° C. up to about room temperature, materials with thermal hysteresis effects and isothermal change in length are disadvantageous, given the possibility of optical disturbances in the case, for example, of optical components such as photomask substrates, photomask carriers, lithography mirrors, and astronomical or space-based mirrors. In the case of other precision components made from glass-ceramic that are employed in measurement technology (e.g. precision rules, reference plates in interferometers), measurement inaccuracies may arise as a result.

Many known materials such as ceramics, Ti-doped quartz glass and particular glass-ceramics feature an average coefficient of thermal expansion CTE (0;50) of 0±0.1×10⁻⁶/K (corresponding to 0±0.1 ppm/K). Materials having a low average CTE of this kind within the stated temperature range are referred to as zero-expansion materials in the context of this invention. However, glass-ceramics, especially LAS glass-ceramics, whose average CTE is optimized in this way generally have a thermal hysteresis in the temperature range of 15° C. to 35° C. In other words, specifically in applications around room temperature (i.e. 22° C.), a disruptive hysteresis effect occurs with these materials, and impairs the accuracy of precision components produced using such a material. Therefore, a glass-ceramic material was developed (see U.S. Pat. No. 4,851,372) that has no significant hysteresis at room temperature, although the effect is not eliminated but has merely been shifted to lower temperatures, so that this glass-ceramic at temperatures of 15° C. and below shows a distinct hysteresis that may likewise still be disruptive. To characterize the thermal hysteresis of a material in a particular temperature range, therefore, the thermal characteristics of the materials in the context of this invention are considered for different temperature points in this range. There are even glass-ceramics that show no significant hysteresis at 22° C. and at 5° C., but these glass-ceramics have an average CTE (0;50) of >0±0.1 ppm/K, and so are not zero-expansion glass-ceramics in the sense of the definition stated above.

A further requirement imposed on a glass-ceramic material is good meltability of the glass components and also simple melt guiding and homogenization of the underlying glass melt in industrial-scale production plants, in order—following ceramization of the glass—to meet the exacting requirements of the glass-ceramic with regard to CTE homogeneity, internal quality—in particular, a low number of inclusions (especially bubbles), low level of stria—and polishability, etc.

What is needed in the art is a way to provide a glass-ceramic having improved expansion characteristics, a way to provide an industrially producible glass-ceramic that has zero expansion and a reduced thermal hysteresis especially in the temperature range of 15° C. to 35° C., and a way to provide a precision component produced from this material. What is also needed in the art is a way to provide a material which in the case of a precision component manufactured therefrom, especially a precision component in EUV lithography, enables a relatively high imaging accuracy.

### SUMMARY OF THE INVENTION

According to one aspect provided according to the invention, a lithium aluminum silicate (LAS) glass-ceramic is provided, having an average coefficient of thermal expansion CTE in a range from 0 to 50° C. of at most 0±0.1×10⁻⁶/K and a thermal hysteresis at least in the temperature range of 15-35° C. of <0.1 ppm and comprising the following components (in mol % based on oxide): SiO 60-<70; Li₂O 7-9.6; MgO+ZnO>0.5-1.5; R₂O>0.5, where R₂O may be Na₂O and/or K₂O and/or Cs₂O and/or Rb₂O; and nucleating agent with a content of 1.5 to 6 mol %, where nucleating agent is at least one component selected from the group consisting of TiO₂, ZrO₂, Ta₂O₅, Nb₂O₅, SnO₂, MoO₃, WO₃, HfO₂.

According to a further aspect, the invention pertains to the use of a glass-ceramic provided according to the invention as a substrate for a precision component, more particularly a precision EUV lithography component.

According to a further aspect, the invention pertains to the use of an LAS glass-ceramic provided according to the invention in a precision component, more particularly for use in metrology, spectroscopy, measurement technology, lithography, astronomy or Earth observation from space, for example as mirror or mirror carrier for segmented or monolithic astronomical telescopes or else as weight-reduced or ultra-light mirror substrates for, for example, space-based telescopes or as high-precision structure components for measurement of distance, for example in space, or optics for Earth observation, as precision components, such as standards for precision measurement technology, precision rules, reference plates in interferometers, as mechanical precision parts, for example for ring laser gyroscopes, spiral springs for the clock industry, as for example mirrors and prisms in LCD lithography, for example as mask holders, wafer stages, reference plates, reference frames and grid plates in microlithography and in EUV (extreme UV) microlithography, where a reflective optical system is employed, and, furthermore, as mirrors and/or photomask substrates or reticle mask blanks or photomask carriers in EUV microlithography.

According to another aspect, the invention pertains to a precision component which comprises an LAS glass-ceramic provided according to the invention.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing(s), wherein:

FIG. 1 shows CTE-T curves of materials known from the prior art that have low thermal lengthwise expansion, for precision components, for example;

FIG. 2 shows the hysteresis characteristics of three glass-ceramic samples, ascertained by the same method also used in the present invention, the diagram originates from R. Jedamzik et al., “Modeling of the thermal expansion behavior of ZERODUR® at arbitrary temperature profiles”, Proc. SPIE Vol. 7739, 2010;

FIGS. 3 to 8 show hysteresis curves of known and non-inventive glass-ceramic materials which can be used for producing known precision component and which have a thermal hysteresis at least in the temperature range of 15-35° C. of >0.1 ppm (dashed=cooling curve, dotted=heating curve);

FIG. 9 shows the hysteresis curve (dashed=cooling curve, dotted=heating curve) of a prior art glass-ceramic which can be used for producing a precision component and which has a thermal hysteresis at least in the temperature range of 15-35° C. of <0.1 ppm, but the steep curve profile shows that the glass-ceramic does not have zero expansion;

FIGS. 10 and 11 show hysteresis curves of glass-ceramics provided according to the invention (compositions as for Examples 2 and 4 in Table 1) which can be used for producing a precision component provided according to the invention and which have a thermal hysteresis at least in the temperature range of 15-35° C. of <0.1 ppm (dashed=cooling curve, dotted=heating curve);

FIG. 12 shows a normalized Δl/l₀−T curve (also called dl/l₀ curve) of a glass-ceramic provided according to the invention (compositions as for Example 2 in Table 1) and reference lines for ascertaining the index F as a measure of the flatness of the expansion curve in the temperature range from 0° C. to 50° C.;

FIGS. 13 to 16 show normalized Δl/l₀−T curves of known materials which can be used for producing known precision component, and reference lines for ascertaining the index F as a measure of the flatness of the expansion curve in the temperature ranges from −20° C. or −10° C. to 70° C. or 80° C.;

FIG. 17 shows normalized Δl/l₀−T curves of known materials in the temperature range from −30° C. to +70° C.;

FIG. 18 shows that the CTE-T curve of the glass-ceramic of FIG. 12, which can be used for producing an advantageous precision component, advantageously has a CTE “plateau”;

FIG. 19 shows the slope of the CTE-T curve from FIG. 18;

FIG. 20 shows a normalized Δl/l₀−T curve of a glass-ceramic provided according to the invention (composition as for Example 2 in Table 1) and reference lines for ascertaining the alternative index f_{(20;40)} as a measure of the flatness of the expansion curve in the temperature range from 20° C. to 40° C.;

FIG. 21 shows a normalized Δl/l₀−T curve of a glass-ceramic provided according to the invention (composition as for Example 2 in Table 1) and reference lines for ascertaining the alternative index f_{(20;70)} as a measure of the flatness of the expansion curve in the temperature range from 20° C. to 70° C.; and

FIG. 22 shows a normalized Δl/l₀−T curve of a glass-ceramic provided according to the invention (composition as for Example 4 in Table 1) and reference lines for ascertaining the alternative index f_{(-10;30)} as a measure of the flatness of the expansion curve in the temperature range from −10° C. to 30° C.

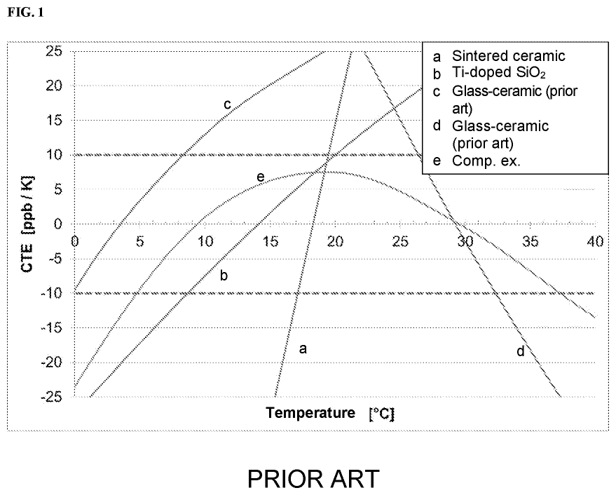

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

A subject provided according to the invention is a lithium aluminum silicate (LAS) glass-ceramic having an average coefficient of thermal expansion CTE in the range from 0 to 50° C. of at most 0±0.1×10⁻⁶/K and a thermal hysteresis at least in the temperature range of 15° C.-35° C. of <0.1 ppm and comprising the following components (in mol % based on oxide):

| | |
|---|---|
| SiO₂ | 60-<70 |
| Li₂O | 7-9.6 |
| MgO + ZnO | >0.5-1.5 |
| R2O | >0.5 |

where R₂O may be Na₂O and/or K₂O and/or Cs₂O and/or Rb₂O, and nucleating agent with a content of 1.5 to 6 mol %, where nucleating agent is at least one component selected from the group consisting of TiO₂, ZrO₂, Ta₂O₅, Nb₂O₅, SnO₂, MoO₃, WO₃, HfO₂.

The invention provides an LAS glass-ceramic (also called glass-ceramic below) that combines a number of relevant properties: it can be produced with high homogeneity in industrial-scale production plants. Additionally, it has an average coefficient of thermal expansion CTE in the range from 0 to 50° C. of at most 0±0.1×10⁻⁶/K, i.e. it has zero expansion. Moreover, it has a thermal hysteresis of <0.1 ppm at least in the temperature range from 15° C. to 35° C. A material having such a low hysteresis effect of <0.1 ppm within the stated temperature range is referred to hereinafter as “hysteresis-free”. Since the extent of the hysteresis, as already mentioned above, is dependent on the rate of temperature change used to ascertain it, the statements relating to hysteresis in the context of the invention refer to a heating rate/cooling rate of 36 K/h, i.e. 0.6 K/min. The low thermal hysteresis in the stated temperature range reduces the cost and effort for compensating thermally induced deformations of a precision component over time when the material is used in a precision component, especially in an EUV lithography component. In some embodiments, the LAS glass-ceramic may at least in the temperature range of 15° C. to 40° C., optionally at least in the temperature range of 15° C. to 45° C., optionally at least in the temperature range from 15° C. to 50° C. or at least in the temperature range from 10° C. to 35° C., be hysteresis-free.

The features of CTE and thermal hysteresis are described in detail further herein.

A glass-ceramic provided in accordance with the invention comprehends non-porous inorganic materials having a crystalline phase and a vitreous phase, with the matrix, i.e. the continuous phase, generally being a glass phase. For production of the glass-ceramic, first of all, the components of the glass-ceramic are mixed, melted and refined, and what is called a green glass is cast. The green glass, after cooling, is crystallized in a controlled manner by reheating (so-called “controlled volume crystallization”). The chemical composition (analysis) of the green glass and of the glass-ceramic produced from it are the same; ceramization alters solely the internal structure of the material. Therefore, where reference is made hereinafter to the composition of the glass-ceramic, the statements made are equally applicable to the precursor article of the glass-ceramic, i.e. to the green glass.

In the prior art, it was assumed to date that the glass components MgO and ZnO in combination or each individually are necessary, specifically for zero-expansion LAS glass-ceramics, in order to achieve the zero expansion and to make the shape of the CTE-T curve of the material “flat”, i.e. with a shallow slope of the CTE-T curve within the relevant temperature range. In DE 10 2022 105 929.4, unpublished at the priority date of the present application, it was recognized by the inventors for the first time that the two components MgO and ZnO promote the occurrence of thermal hysteresis within the temperature range under consideration and that therefore it is essential to the provision of a zero-expansion LAS glass-ceramic which is hysteresis-free at least in the temperature range of 10° C. to 35° C. to limit the MgO and ZnO content or even to omit them entirely. Consequently, there was a conflict of objectives in that an LAS glass-ceramic could be either zero-expansion or hysteresis-free.

This conflict of objectives was resolved, with the technical teaching of DE 10 2022 105 929.4, unpublished at the priority date of the present application, by not only doing largely without the use of MgO and ZnO but also selecting the SiO₂ and Li₂O contents from stipulated ranges as well.

A problem affecting these zero-expansion and hysteresis-free glass-ceramics, however, can be the establishment of the profile for the expansion curve and hence for the CTE. The expansion curves for the glass-ceramics with a low sum total of MgO+ZnO in some cases, rather than being flat as desired, are sharply curved specifically within the temperature range between 0° C. and 50° C. The inventors have discovered that through a deliberate addition of more than 0.5 mol % of alkali metal oxides (R₂O), selected from the group consisting of Na₂O and/or K₂O and/or Cs₂O and/or Rb₂O, glass-ceramics with a flat expansion curve are obtained, surprisingly, and hence also the total MgO+ZnO content, as claimed in the context of the present invention, can be higher with addition of more than 0.5 mol % of R₂O, with the resulting glass-ceramics nevertheless being hysteresis-free at least in the temperature range from 15° C. to 35° C.—that is, in a temperature interval which includes room temperature.

LAS glass-ceramics contain a negatively expanding crystal phase which, in accordance with the invention, may advantageously comprise or consist of high quartz solid solution, also called β-eucryptite, and a positively expanding glass phase. As well as SiO₂ and Al₂O₃, Li₂O is a main constituent of the solid solution. If present, ZnO and/or MgO are likewise incorporated into the solid solution phase, and together with Li₂O influence the expansion characteristics of the crystal phase. In contrast to the known zero-expansion glass-ceramics in which MgO and ZnO in particular are used for establishing the desired expansion characteristics of the glass-ceramic, the invention for this purpose uses R₂O, where R₂O may be Na₂O and/or K₂O and/or Rb₂O and/or Cs₂O. Unlike MgO and ZnO, however, the stated alkali metal oxides remain in the glass phase and are not incorporated into the high quartz solid solution.

In the context of the invention, it has been found that for the provision of a zero-expansion and hysteresis-free glass-ceramic, it may be advantageous if the composition meets the condition of molar content of SiO₂+(5×molar content of Li₂O)≥105, optionally ≥105.5, optionally ≥106 or optionally ≥106.5, optionally molar content of SiO₂+(5×molar content of Li₂O)≥107 or ≥107.5. Alternatively or additionally, for the condition of “molar content SiO₂+(5×molar content of Li₂O)”, an advantageous upper limit of ≤115.5 or of ≤114.5 or of ≤113.5 may apply.

In some embodiments, the glass-ceramic may comprise the following components, individually or in any combination, in mol %:

| | |
|---|---|
| Al₂O₃ | 10 to 22 |
| P₂O₅ | 0 to 6 |
| MgO | 0 to 1.1 |
| ZnO | 0 to 1.5 |
| R₂O | >0.5 to 6 |
| RO | 0 to 6 |
| TiO₂ + ZrO₂ | 1.5 to 6. |

In some embodiments, within the scope of the limits stated above for the sum totals of R₂O, RO and TiO₂+ZrO₂, the glass-ceramic may contain the following components, individually or in any combination, in mol %:

| | |
|---|---|
| Na₂O | 0 to 3 |
| K₂O | 0 to 3 |
| Cs₂O | 0 to 2 |
| Rb₂O | 0 to 2 |
| CaO | 0 to 5 |
| BaO | 0 to 4 |
| SrO | 0 to 3 |
| TiO₂ | 0 to 5 |
| ZrO₂ | 0 to 3. |

In some embodiments, the LAS glass-ceramic comprises (in mol % based on oxide):

| | |
|---|---|
| Al₂O₃ | 10 to 22 |
| P₂O₅ | 0 to 6 |
| MgO | 0 to 1.0 |
| ZnO | 0 to 1.4 |
| R2O | 0.6 to 5 |
| RO | 0 to 6 |
| Nucleating agent | 1.5 to 6, |

where nucleating agent is optionally TiO₂ and/or ZrO₂.

In some embodiments, the LAS glass-ceramic comprises (in mol % based on oxide):

| | |
|---|---|
| SiO₂ | 60.50 to 69 |
| Li₂O | 8 to 9.6 |
| Al₂O₃ | 11 to 21 |
| P₂O₅ | 0 to 4 |
| MgO | 0 to 1.1 |
| ZnO | 0 to 1.5 |
| R2O | >0.5 to 4 |
| RO | 0.2 to 4.5 |
| Nucleating agent | 2.5 to 5, |

where nucleating agent is optionally TiO₂ and/or ZrO₂.

The glass-ceramic contains a fraction of silicon dioxide (SiO₂) of at least 60 mol %, optionally at least 60.5 mol %, optionally at least 61 mol %, optionally at least 61.5 mol %, optionally at least 62.0 mol %. The fraction of SiO₂ is less than 70 mol %, optionally at most 69.5 mol %, optionally at most 69 mol %, optionally at most 68.5 mol %. With larger fractions of SiO₂, the batch is more difficult to melt, and the viscosity of the melt is higher, which can lead to problems affecting the homogenization of the melts in industrial-scale production plants. The SiO₂ content ought therefore to be less than 70 mol %. If the viscosity of a melt is high, there is an increase in the processing temperature Va of the melt. Refining and homogenization of the melt require very high temperatures, which, however, mean that the increasing aggressiveness of the melt with temperature results in attacks on the linings of the melting assemblies. Moreover, even higher temperatures may not be enough to generate a homogeneous melt, with the consequence that the green glass may have stria and inclusions (especially bubbles and particles originating from the lining of the melting assemblies), so that, after ceramization, the glass-ceramic that is produced fails to meet the requirements in terms of homogeneity of properties, such as the homogeneity of the coefficient of thermal expansion, for example. SiO₂ contents lower than the stated upper limit may be used for this reason.

The fraction of Al₂O₃ may be at least 10 mol %, optionally at least 11 mol %, optionally at least 12 mol %, optionally at least 13 mol %, optionally at least 14 mol %, optionally at least 14.5 mol %, optionally at least 15 mol %. If the content is too low, formation of low-expansion solid solution is inadequate or absent. The fraction of Al₂O₃ may be at most 22 mol %, optionally at most 21 mol %, optionally at most 20 mol %, optionally at most 19.0 mol %, optionally at most 18.5 mol %. Too high an Al₂O₃ content leads to increased viscosity and promotes uncontrolled devitrification of the material.

The glass-ceramic provided according to the invention may contain 0 to 6 mol % of P₂O₅. The P₂O₅ phosphate content of the glass-ceramic may be at least 0.1 mol %, optionally at least 0.3 mol %, optionally at least 0.5 mol %, optionally at least 0.6 mol %, optionally at least 0.7 mol %, optionally at least 0.8 mol %. P₂O₅ is incorporated substantially into the crystal phase of the glass-ceramic and has positive influence on the expansion characteristics of the crystal phase and hence of the glass-ceramic. Moreover, melting of the components and refining characteristics of the melt are improved. If, however, too much P₂O₅ is present, the profile of the CTE-T curve in the 0° C. to 50° C. temperature range does not exhibit an advantageous flat progression. Advantageously, therefore, there ought to be not more than 6 mol %, optionally not more than 5 mol %, optionally at most 4 mol %, optionally less than 4 mol % of P₂O₅ present in the glass-ceramic. In some embodiments, the glass-ceramics may be free of P₂O₅.

In the context of the invention, certain sum totals and proportions of the components SiO₂, Al₂O₃ and/or P₂O₅, i.e. of the components which form the high quartz solid solution, may be conducive to the formation of a glass-ceramic provided according to the invention.

The cumulative fraction in mol % of the SiO₂ and Al₂O₃ base constituents of the LAS glass-ceramic may be at least 75 mol %, optionally at least 78 mol %, optionally at least 79 mol %, optionally at least 80 mol % and/or optionally at most 90 mol %, optionally at most 87 mol %, optionally at most 86 mol %, optionally at most 85 mol %. If this sum total is too high, the viscosity curve of the melt is shifted to higher temperatures, which is disadvantageous, as already elucidated above in connection with the SiO₂ component. If the sum total is too low, too little solid solution is formed.

The cumulative fraction in mol % of the SiO₂, Al₂O₃ and P₂O₅ base constituents of the LAS glass-ceramic is optionally at least 77 mol %, optionally at least 81 mol %, optionally at least 83 mol %, optionally at least 84 mol % and/or optionally at most 91 mol %, optionally at most 89 mol %, optionally at most 87 mol %, optionally at most 86 mol %.

The ratio of the mol % fractions of P₂O₅ to SiO₂ is optionally at least 0.005, optionally at least 0.01, optionally at least 0.012 and/or optionally at most 0.1, optionally at most 0.08, optionally at most 0.07.

As a further constituent, the glass-ceramic contains lithium oxide (Li₂O) in a fraction of at least 7 mol %, optionally at least 7.5 mol %, optionally at least 8 mol %, optionally at least 8.25 mol %. The fraction of Li₂O is limited to at most 9.6 mol %, optionally at most 9.5 mol %, optionally at most 9.4 mol %, optionally at most 9.35 mol %, optionally at most or less than 9.3 mol %. Li₂O is a constituent of the solid solution phase and makes a substantial contribution to the thermal expansion of the glass-ceramic. The stated upper limit of 9.6 mol % ought not to be exceeded, since otherwise, in spite of the total MgO+ZnO content according to the invention, the resulting glass-ceramics have a negative coefficient of thermal expansion CTE (0;50). If the Li₂O content is less than 7 mol %, too little solid solution is formed and the CTE of the glass-ceramic remains positive.

The glass-ceramic provided according to the invention contains more than 0.5 mol % of alkali metal oxide R₂O, where R₂O may be Na₂O and/or K₂O and/or Cs₂O and/or Rb₂O. In accordance with the invention, surprisingly, an R₂O content of more than 0.5 mol % contributes to producing a glass-ceramic having a flat profile of the expansion curve, even with a relatively high sum total of MgO+ZnO. The sum total R₂O for the Na₂O, K₂O, Cs₂O and Rb₂O contents may be at least 0.55 mol %, optionally at least 0.6 mol %, optionally at least 0.65 mol %, optionally at least 0.7 mol %, optionally at least 0.75 mol %. Certain variants may contain at least 0.8 mol %, optionally at least 0.85 mol %, optionally at least 0.9 mol %, optionally at least 0.95 mol %, optionally at least 1.0 mol % of R₂O. The sum total R₂O for the Na₂O, K₂O, Cs₂O and Rb₂O contents may be at most 6 mol %, optionally at most 5 mol %, optionally at most 4 mol %, optionally at most 3 mol %, optionally at most 2.5 mol %. If the sum total of Na₂O+K₂O+Cs₂O+Rb₂O is too low or too high, it can be possible that the CTE (0;50) targeted by the invention is not achieved. Too much R₂O in the glass-ceramic, however, impairs the chemical resistance of the material. If the sum total of Na₂O+K₂O+Cs₂O+Rb₂O is too low, the expansion curve for the material exhibits a curved portion in the temperature range under consideration, and the glass-ceramic with a total MgO+ZnO content in accordance with the invention is not hysteresis-free in the sense of the invention.

Within the limits stated above for the sum total of R₂O, the individual components sodium oxide (Na₂O), potassium oxide (K₂O), caesium oxide (Cs₂O) and rubidium oxide (Rb₂O) are present optionally in the glass-ceramic, meaning that Na₂O-free and/or K₂O-free and/or Cs₂O-free and/or Rb₂O-free variants are possible. The fraction of Na₂O may be at most 3 mol %, optionally at most 2 mol %, optionally at most 1.7 mol %, optionally at most 1.5 mol %, optionally at most 1.3 mol %, optionally at most 1.1 mol %. The fraction of K₂O may be at most 3 mol %, optionally at most 2.5 mol %, optionally at most 2 mol %, optionally at most 1.8 mol %, optionally at most 1.7 mol %. The fraction of Cs₂O may be at most 2 mol %, optionally at most 1.5 mol %, optionally at most 1 mol %, optionally at most 0.6 mol %. The fraction of Rb₂O may be at most 2 mol %, optionally at most 1.5 mol %, optionally at most 1 mol %, optionally at most 0.6 mol %. According to some embodiments, the glass-ceramics are free of Na₂O and/or K₂O and/or Cs₂O and/or Rb₂O.

Na₂O and K₂O, in each case and independently of one another, may be present in a fraction of at least 0.05 mol %, optionally at least 0.1 mol %, optionally at least 0.15 mol %, optionally at least 0.2 mol %, optionally at least 0.25 mol %, optionally at least 0.3 mol %, optionally at least 0.35 mol %, optionally at least 0.4 mol %, optionally at least 0.45 mol %, optionally at least 0.5 mol %, in the glass-ceramic. The stated limits may also apply for Cs₂O and Rb₂O. The Na₂O, K₂O, Cs₂O and Rb₂O components remain substantially in the amorphous glass phase of the glass-ceramic and may be important for preserving the zero expansion of the ceramized material.

The glass-ceramic may contain at least one alkaline earth metal oxide selected from the group consisting of CaO, BaO and SrO, with this group being referred to collectively as “RO”. The components from the RO group remain essentially in the amorphous glass phase of the glass-ceramic and may be important for preserving the zero expansion of the ceramized material. If the sum total of CaO+BaO+SrO is too high, the target CTE (0;50) provided according to the invention is not achieved. Therefore, the fraction of RO is optionally at most 6 mol % or at most 5.5 mol %, optionally at most 5 mol %, optionally at most 4.5 mol %, optionally at most 4 mol %, optionally at most 3.8 mol %, optionally at most 3.5 mol %, optionally at most 3.2 mol %. If the glass-ceramic contains RO, an advantageous lower limit may be at least 0.1 mol %, optionally at least 0.2 mol %, optionally at least 0.3 mol %, optionally at least 0.4 mol %. According to some embodiments, the glass-ceramics may be free of RO.

The fraction of CaO may optionally be at most 5 mol %, optionally at most 4 mol %, optionally at most 3.5 mol %, optionally at most 3 mol %, optionally at most 2.8 mol %, optionally at most 2.6 mol %. The glass-ceramic may optionally contain at least 0.1 mol %, optionally at least 0.2 mol %, optionally at least 0.4 mol %, optionally at least 0.5 mol % of CaO. The glass-ceramic may optionally contain the component BaO, which is a good glass-former, in a fraction of at least 0.1 mol %, optionally at least 0.2 mol % and/or at most 4 mol %, optionally at most 3 mol %, optionally at most 2.5 mol %, optionally at most 2 mol %, optionally at most 1.5 mol %, optionally at most 1.4 mol %. The glass-ceramic may contain SrO in a fraction of at most 3 mol %, optionally at most 2 mol %, optionally at most 1.5 mol %, optionally at most 1.3 mol %, optionally at most 1.1 mol %, optionally at most 1 mol %, optionally at most 0.9 mol % and/or optionally at least 0.1 mol %. According to some embodiments, the glass-ceramics are free from CaO and/or BaO and/or SrO. According to some embodiments, the glass-ceramic contains CaO.

The glass-ceramic provided according to the invention has a sum total of MgO+ZnO in the range of >0.5 to 1.5 mol %. An advantageous lower limit for the sum total may be at least 0.55 mol %, optionally at least 0.6 mol %, optionally at least 0.65 mol %, optionally at least 0.7 mol %, optionally at least 0.75 mol %. At maximum, the glass-ceramic contains 1.5 mol % of MgO+ZnO. An advantageous upper limit may be less than 1.5 mol %, optionally not more than 1.45 mol %, optionally not more than 1.4 mol %, optionally not more than 1.35 mol %, optionally not more than 1.3 mol %, optionally not more than 1.25 mol %, optionally not more than 1.2 mol %, optionally not more than 1.15 mol %, optionally not more than 1.1 mol %, optionally not more than 1.05 mol %, optionally not more than 1.0 mol %, optionally not more than 0.95 mol %. If the sum total of MgO+ZnO is too high, the glass-ceramics have a thermal hysteresis of >0.1 ppm in the temperature range of 15° C. to 35° C.

The glass-ceramic may contain magnesium oxide (MgO) with a content of 0 to 1.1 mol %. An advantageous MgO upper limit may be 1.1 mol %. If the MgO content is too high, the material exhibits a thermal hysteresis of 0.1 ppm or more in the claimed temperature range. A further advantageous upper limit may be not more than 1.05 mol %, not more than 1.0 mol %, not more than 0.95 mol %, not more than 0.9 mol %, not more than 0.85 mol % or not more than 0.8 mol %. The addition of MgO may be useful for keeping the CTE low, especially in the case of relatively high Li₂O contents, for providing a zero-expansion glass-ceramic. If MgO is present in the glass-ceramic, an advantageous MgO lower limit may be 0.05 mol % or 0.1 mol % or 0.15 mol % or 0.2 mol % or 0.25 mol % or 0.3 mol %. Certain variants may also contain at least 0.35 mol % or 0.4 mol % or 0.45 mol % or 0.5 mol % or more than 0.5 mol % of MgO. Some embodiments of the glass-ceramic may be free of MgO.

The glass-ceramic may contain zinc oxide (ZnO) with a content of 0 to 1.5 mol %. An advantageous upper limit may be 1.5 mol %. If the ZnO content is too high, the material exhibits a thermal hysteresis of 0.1 ppm or more in the claimed temperature range. A further advantageous upper limit may be not more than 1.45 mol %, not more than 1.4 mol %, not more than 1.35 mol %, not more than 1.3 mol %, not more than 1.25 mol %, not more than 1.2 mol %, not more than 1.15 mol %, not more than 1.1 mol %, not more than 1.05 or not more than 1.0 mol %. Certain embodiments may also contain not more than 0.95 mol % or not more than 0.9 mol % or not more than 0.85 mol % or not more than 0.8 mol % of ZnO. If ZnO is present in the glass-ceramic, an advantageous ZnO lower limit may be 0.05 mol % or 0.1 mol % or 0.15 mol % or 0.2 mol % or 0.25 mol % or 0.3 mol %. Certain variants may also contain 0.35 mol % or 0.4 mol % or 0.45 mol % or 0.5 mol % or more than 0.5 mol % of ZnO. Some embodiments of the glass-ceramic may be free of ZnO.

The glass-ceramic further contains at least one crystal nucleating agent selected from the group consisting of TiO₂, ZrO₂ Ta₂O₅, Nb₂O₅, SnO₂, MoO₃, WO₃ and HfO₂. Nucleating agent may be a combination of two or more of the stated components. A further advantageous nucleating agent may be HfO₂. In some embodiments, therefore, the glass-ceramic comprises HfO₂ and at least one crystal nucleating agent selected from the group consisting of TiO₂, ZrO₂ Ta₂O₅, Nb₂O₅, SnO₂, MoO₃ and WO₃. The sum total of the fractions of the nucleating agents is optionally at least 1.5 mol %, optionally at least 2 mol % or more than 2 mol %, optionally at least 2.5 mol %, in certain variants at least 3 mol %. An upper limit may be not more than 6 mol %, optionally not more than 5 mol %, optionally not more than 4.5 mol % or not more than 4 mol %. In some embodiments, the stated upper and lower limits are applicable to the sum total of TiO₂ and ZrO₂.

The glass-ceramic may contain titanium oxide (TiO₂) optionally with a fraction of at least 0.1 mol %, optionally at least 0.5 mol %, optionally at least 1.0 mol %, optionally at least 1.5 mol %, optionally at least 1.8 mol % and/or optionally at most 5 mol %, optionally at most 4 mol %, optionally at most 3 mol %, optionally at most 2.5 mol %, optionally 2.3 mol %. TiO₂-free variants of the glass-ceramic provided according to the invention are possible.

The glass-ceramic may further contain zirconium oxide (ZrO₂) in a fraction of at most 3 mol %, optionally at most 2.5 mol %, optionally at most 2 mol %, optionally at most 1.5 mol % or at most 1.2 mol %. ZrO₂ may be present optionally in a fraction of at least 0.1 mol %, optionally at least 0.5 mol %, at least 0.8 mol % or at least 1.0 mol %. ZrO₂— free variants of the glass-ceramic provided according to the invention are possible.

According to some variants provided according to the invention, individually or in total, there may be 0 to 5 mol % of Ta₂O₅ and/or Nb₂O₅ and/or SnO₂ and/or MoO₃ and/or WO₃ present in the glass-ceramic, serving, for example, as alternative or additional nucleating agents or for modulating the optical properties, e.g. refractive index. HfO₂ may likewise be an alternative or additional nucleating agent. For modulating the optical properties it is possible in some variants for—for example—Gd₂O₃, Y₂O₃, HfO₂, Bi₂O₃ and/or GeO₂ to be present.

The glass-ceramic may further contain one or more customary refining agents, selected from the group consisting of As₂O₃, Sb₂O₃, SnO₂, SO₄, F⁻, Cl⁻, Br⁻, or a mixture thereof, in a fraction of more than 0.05 mol % or at least 0.1 mol % and/or at most 1 mol %. However, fluorine as refining agent may lower the transparency of the glass-ceramic and/or the chemical resistance, and so this component, if present, is limited optionally to not more than 0.5 mol %, optionally not more than 0.3 mol %, optionally not more than 0.1 mol %. The glass-ceramic is optionally free of fluorine.

According to some embodiments, the glass-ceramic may contain not more than 0.05 mol % of As₂O₃ as refining agent, and according to some embodiments may be free of As₂O₃. It may be advantageous for the glass-ceramic, instead of or in addition to optionally not more than 0.05 mol % of As₂O₃, to comprise at least one alternative redox refining agent and/or at least one evaporating refining agent and/or at least one decomposing refining agent.

The alternative redox refining agents, which contain multivalent or polyvalent ions able to occur at least in two oxidation states, present in a temperature-dependent equilibrium to one another, where a gas, usually oxygen, is released at high temperatures, include, for example, Sb₂O₃, SnO₂, MnO₂, CeO₂ and Fe₂O₃.

The evaporating refining agents, which are volatile at high temperatures by virtue of their vapour pressure, include halogens with refining effect, such as Cl, Br and I, for example.

The decomposing refining agents, which decompose at high temperatures while giving off refining gas, and the decomposition product having a sufficiently high gas pressure, include, for example, salts which contain oxo anions, more particularly a sulfate component, which in materials analysis is determined as SO₃.

Combinations of the above-stated chemical refining agents may also be advantageous.

Some embodiments may comprise:
SnO₂ and/or Sb₂O₃ each with maximum 0.05 mol % of As₂O₃; or
As₂O₃-free combinations such as: Sb₂O₃ with SnO2; Sb₂O₃ with Cl, Sb₂O₃ with SO₃; or
As₂O₃-free and Sb₂O₃-free combinations such as: SnO₂ with Cl, SnO₂ with SO₃, Cl with SO₃.

The above glass compositions may optionally contain additions of coloring oxides, such as, for example, Nd₂O₃, Fe₂O₃, CoO, NiO, V₂O₅, MnO₂, CuO, CeO₂, Cr₂O₃, rare earth oxides in contents of, in each case individually or in total, 0-3 mol %. Some variants are free of colouring oxides.

B₂O₃ may have an adverse effect on the transparency of the glass-ceramic. The content of this component, therefore, in some variants is limited to <0.2 mol %, optionally at most 0.1 mol %. Some variants are free of B₂O₃.

According to some embodiments provided according to the present invention, the composition is free of components not mentioned above.

According to some embodiments provided according to the present invention, the glass-ceramic provided according to the invention or the green glass consists optionally to an extent of at least 90 mol %, optionally to an extent of at least 95 mol %, optionally to an extent of at least 99 mol %, of the abovementioned components, and optionally of the components SiO₂, Al₂O₃, Li₂O, MgO, ZnO, P₂O₅, R₂O, RO and nucleating agents.

According to some embodiments of the glass-ceramic provided according to the present invention, it is substantially free of a glass component or two or more glass components selected from the group consisting of PbO, B₂O₃, CrO₃, F, and Cd compounds.

According to the invention, the expression “X-free” or “free of a component X” means that the glass-ceramic substantially does not contain this component X, i.e. that such a component is present at most as an impurity in the glass, but is not added to the composition as an individual component. For other glass components, higher impurity contents of up to not more than 0.1 mol %, optionally not more than 0.05 mol %, optionally not more than 0.01 mol %, optionally not more than 0.005 mol %, for certain components optionally not more than 0.003 mol %, based in each case on one component, may be possible. X here represents any component, for example PbO.

The glass-ceramics provided according to the invention comprise high quartz solid solution as the main crystal phase. The main crystal phase is the crystalline phase having the greatest vol % fraction in the crystal phase. High quartz solid solution is a metastable phase which, depending on the crystallization conditions, changes its composition and/or structure or is transformed into a different crystal phase. The high quartz-containing solid solutions have very low thermal expansion or even falling thermal expansion with rising temperature. In some embodiments, the crystal phase contains no β-spodumene and no keatite.

Some embodiments of the LAS glass-ceramic have a crystal phase fraction of less than 75 vol % and/or advantageously more than 45 vol %. The crystal phase consists of high quartz solid solution, which is also called β-eucryptite solid solution. The average crystallite size of the high quartz solid solution may be <100 nm, optionally <80 nm, optionally <70 nm. The effect of the small crystallite size is that the glass-ceramic is transparent and can also be more effectively polished. In some embodiments, the average crystallite size of the high quartz solid solution may be ≤60 nm, optionally <50 nm. The crystal phase, its fraction and the average crystallite size are determined in a known manner by x-ray diffraction analysis.

According to some embodiments provided according to the present invention, a transparent glass-ceramic is produced. The transparency allows numerous properties of such a glass-ceramic to be assessed more effectively, in particular, of course, the internal quality of the glass-ceramic. The glass-ceramics provided according to the invention are transparent, meaning that they have an internal transmission of at least 70% in the wavelength range from 350 to 650 nm. B₂O₃ and/or relatively high fluorine contents may reduce the transparency. Some embodiments therefore do not contain one or both of the stated components. Additionally, the glass-ceramics produced in the context of the invention are pore-free and crack-free. In the context of the invention, “pore-free” means a porosity of less than 1%, optionally less than 0.5%, optionally of less than 0.1%. A crack is a gap, i.e. discontinuity, in an otherwise continuous structure.

In order to enable the manufacture of a homogeneous glass-ceramic in industrial-scale production plant, it may be advantageous if the processing temperature Va or the T4 value of the parent green glass of the glass-ceramic is not more than 1330° C., optionally not more than 1320° C. Some embodiments may have a processing temperature of not more than 1310° C. or not more than 1300° C. or less than 1300° C. The processing temperature Va is the temperature at which the melt has a viscosity of 10⁴ dPas. Homogeneity relates in particular to the homogeneity of the CTE of the glass-ceramic over a large volume, and also a small number of, optionally freedom from, inclusions such as bubbles and particles. This is a quality feature of the glass-ceramic and a prerequisite for use in precision components, especially in very large precision components.

It may additionally be advantageous if the T3 value of the parent green glass of the glass-ceramic is not more than 1550° C., optionally not more than 1525° C. and optionally not more than 1500° C. Some embodiments, indeed, have T3 values of not more than 1490° C. or not more than 1450° C. When the values are situated in this range, the green glass has good meltability and homogenizability.

The processing temperature is determined by the composition of the glass-ceramic. Since the glass network-forming SiO₂ component in particular is regarded for the purpose of increasing the viscosity and hence the processing temperature, the maximum SiO₂ content should be selected in line with the stipulations mentioned above. Moreover, the alkali metal oxide content and the total MgO+ZnO content lower the viscosity of the melt, causing the processing temperature to fall. This leads to an improvement in the homogeneity of the melt and hence of the green glass body generated, and of a glass-ceramic resulting from them.

CTE

The glass-ceramics provided according to the invention have zero expansion (see Table 1), meaning that they have an average coefficient of thermal expansion CTE in the range from 0 to 50° C. of at most 0±0.1×10⁻⁶/K. Some embodiments even have an average CTE in the range from 0 to 50° C. of at most 0±0.05×10⁻⁶/K. For particular applications it may be advantageous if the average CTE over a wider temperature range, for example in the range from −30° C. to +70° C., optionally in the range from −40° C. to +80° C., is at most 0±0.1×10⁻⁶/K, i.e. if there is zero expansion.

For the determination of the CTE-T curve of the glass-ceramics and precision components provided according to the invention and of the comparative examples, the differential CTE(T) is first determined. The differential CTE(T) is determined as a function of the temperature. The CTE is then defined according to the following formula (1):

CTE (T)=(1/l₀)×(∂1/∂T) (1)

To create a Δl/l₀−T curve or an expansion curve or plot of the change in length Δl/l₀ of a test specimen (glass-ceramic or precision component) against the temperature, it is possible to measure the temperature-dependent change in length of the length of a test specimen from the starting length l₀ at the starting temperature t₀ to the length lₜ at the temperature t. Temperature intervals chosen in this case are optionally small, being for example 5° C. or 3° C. or 1° C., for the determination of a measurement point. Such measurements may be conducted, for example, by dilatometric methods, interferometric methods, for example the Fabry-Pérot method, i.e. the evaluation of the shift in the resonance peak of a laser beam injected into the material, or other suitable methods. In the context of the invention, the dilatometric method has been chosen, with a temperature interval of 1° C. on rod-shaped samples of the test specimens with length 100 mm and a diameter of 6 mm for the purpose of ascertaining the CTE. The chosen method of determining the CTE has an accuracy of optionally at least ±0.05 ppm/K, optionally of at least ±0.03 ppm/K. Of course, however, the CTE may also be determined by methods which have an accuracy of at least ±0.01 ppm/K, optionally at least ±0.005 ppm/K or, according to certain embodiments, even of at least ±0.003 ppm/K or at least ±0.001 ppm/K.

The Δl/l₀−T curve is used to calculate the average CTE for a particular temperature interval, for example for the temperature range from 0° C. to 50° C.

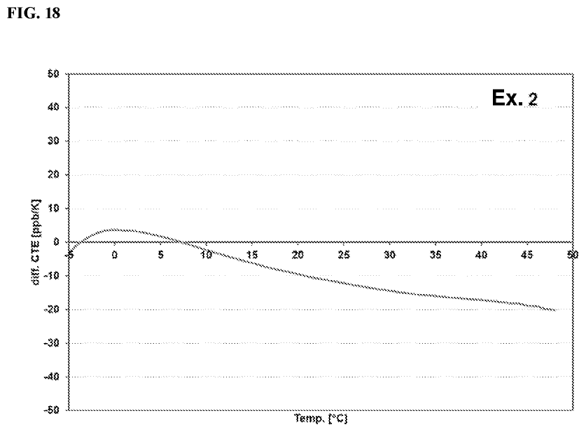

A CTE-T curve is obtained through the derivative of the Δl/l₀−T curve. The CTE-T curve can be used to determine the zero crossing, the slope of the CTE-T curve within a temperature interval. The CTE-T curve is used to determine the shape and position of an advantageous CTE “plateau” formed in certain variants (see below and FIG. 18).

One exemplary configuration of a precision component comprising a glass-ceramic provided according to the invention (especially in the form of a substrate) has a high CTE homogeneity. The value of CTE homogeneity (“total spatial variation of CTE”) is understood here as what is called the peak-to-valley value, i.e. the difference between the respectively highest and lowest CTE values of the samples taken from a precision component. The CTE homogeneity is therefore based not on the CTE of the material of the component but rather on the spatial variation of the CTE over the section under consideration or the entire precision component. For determining the CTE homogeneity, a multiplicity of samples are taken from different sites in a precision component and the CTE value is determined for each of them, reported in ppb/K, where 1 ppb/K=0.001×10⁻⁶/K. The CTE homogeneity, i.e. the spatial variation of the CTE, over the entire precision component is optionally at most 5 ppb/K, optionally at most 4 ppb/K, optionally at most 3 ppb/K. A method for ascertaining the CTE homogeneity and measures for achieving the CTE homogeneity are described in WO 2015/124710 A, the disclosure content of which is incorporated in full into this application.

Thermal Hysteresis

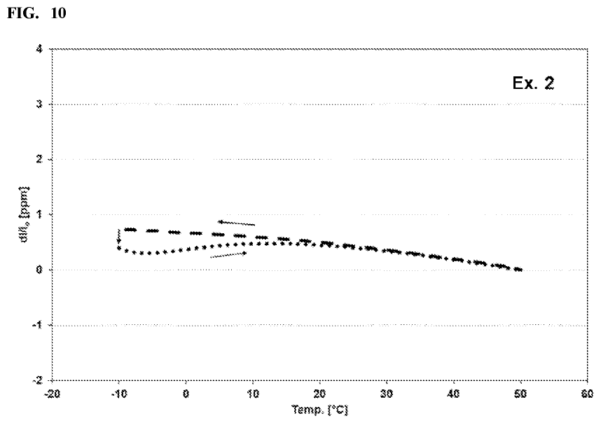

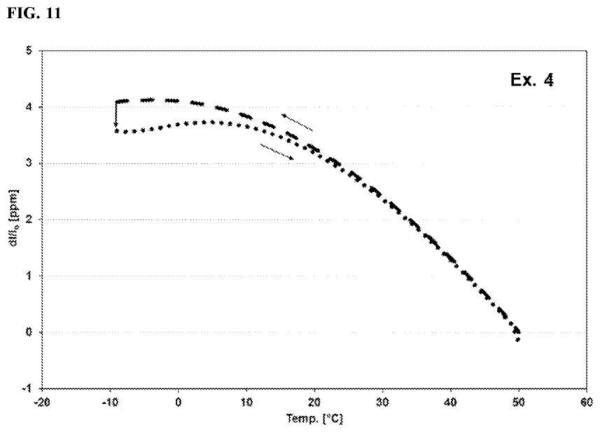

In the context of the invention, the glass-ceramic, at least in the temperature range from 15° C. to 35° C., has a thermal hysteresis of <0.1 ppm and is therefore hysteresis-free (see FIGS. 10 and 11). At any temperature within the temperature interval from 15° C. to 35°, therefore, the glass-ceramic, after having been subjected to a change in temperature with a heating rate or cooling rate of 36 K/h, i.e. 0.6 K/min, after a hold time of 5 hours at constant temperature exhibits an isothermal change in length of less than 0.1 ppm.

“Thermal hysteresis of <0.1 ppm at least in the temperature interval from 15° C. to 35° C.” therefore means that within this temperature interval, after a thermal treatment and subsequent holding at constant temperature, the glass-ceramic has a change in length of <0.1 ppm, based on a heating rate or cooling rate of 36 K/h, i.e. 0.6 K/min, and a hold time of 5 hours at −10° C. The feature of thermal hysteresis therefore describes the thermal characteristics of the glass-ceramic or of a component manufactured from it, over time.

In some embodiments, this freedom from hysteresis is present at least in a temperature range from 15 to 40° C. or at least in the temperature range of 10° C. to 35° C., optionally at least in the temperature range of 15 to 45° C., optionally at least in the temperature range of 15° C. to 50° C. In some embodiments, the temperature range of the freedom from hysteresis is even wider, and so the material or the component is also suitable for applications at temperatures of up to at least 100° C. and above as well. In some embodiments, the temperature range of the freedom from hysteresis is even wider. Exemplary application temperatures are in the −60 to 100° C. range, optionally from −40° C. to +80° C. Some variants provided according to the present invention relate to glass-ceramics and precision components for application temperatures T_{A} for example in the range of 5° C. to 20° C. or T_{A} of 22° C., 40° C., 60° C., 80° C. and 100° C., which are optionally hysteresis-free at these temperatures as well.

The thermal hysteresis was determined for the glass-ceramics and precision components provided according to the invention and for the comparative examples using a precision dilatometer capable of ascertaining the CTE with a reproducibility of ±0.001 ppm/K and ±0.003 ppm/K absolutely, with a temperature interval of 1° C., on rod-shaped samples of length 100 mm and a diameter of 6 mm of the test specimens (i.e. sample of the precision component or sample of the glass-ceramic), in accordance with the method and apparatus construction disclosed in DE 10 2015 113 548 A, the disclosure content of which is incorporated in full into this application. For each sample analysed, the change in length Δl/l₀ was determined as a function of the temperature between 50° C., cooling at a cooling rate of 36 K/h, to −10° C.

After an isothermal hold time of 5 hours at −10° C., the sample was heated at a heating rate of 36 K/h to 50° C. and the change in length Δl/l₀ was recorded as a function of the temperature. The thermal hysteresis characteristics of a test specimen are considered at −5° C., 0° C., 5° C., 10° C., 15° C., 19° C., 22° C., 35° C. and 40° C. These points are representative of the temperature range from −10° C. to 50° C., since hysteresis decreases with rising temperature within the temperature interval stated. Hence a sample which is hysteresis-free at 22° C. or 35° C. also shows no hysteresis in the range up to 50° C.

For determining the thermal hysteresis at 15° C., the individual measurement values of the change in length for the five temperatures of 13° C., 14° C., 15° C., 16° C. and 17° C., i.e. two temperature points above and two temperature points below 15° C., were recorded both during heating and during cooling of the sample in the range of −10° C. to 50° C. at the rate of 36 K/h. The differences in the measurement values for heating curve and cooling curve at these five measurement points were used to form the average, which is listed as “Hyst.@15° C.” in the unit [ppm] in the tables.

For determining the thermal hysteresis at 35° C., correspondingly, the individual measurement values of the change in length for the five temperatures of 33° C., 34° C., 35° C., 36° C. and 37° C., i.e. two temperature points above and two temperature points below 35° C., were recorded both during heating and during cooling of the sample in the range of −10° C. to 50° C. at the rate of 36 K/h. The differences in the measurement values for heating curve and cooling curve at these five measurement points were used to form the average, which is listed as “Hyst.@35° C.” in the unit [ppm] in the tables.

Corresponding procedures were adopted for the other temperature points referred to above.

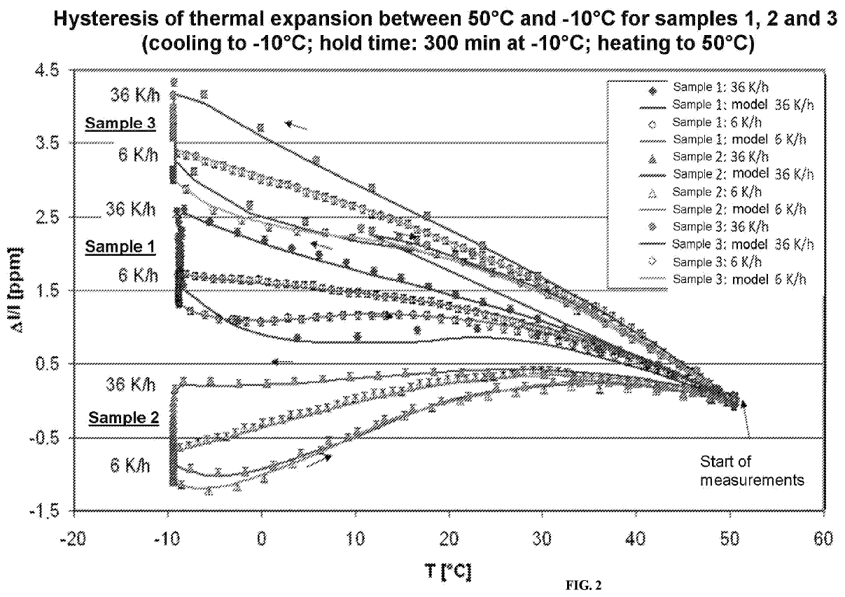

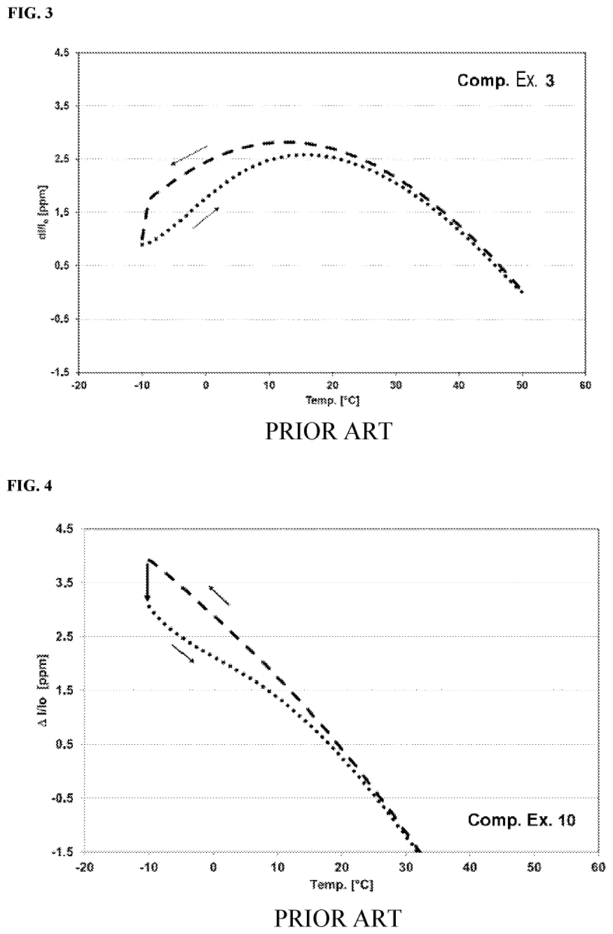

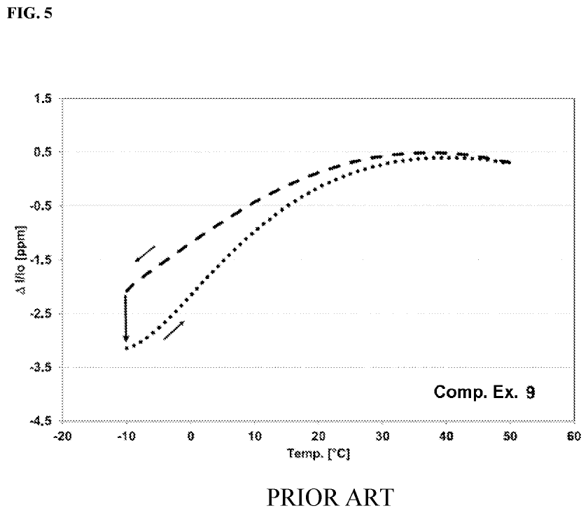

FIGS. 2 to 11 show thermal hysteresis curves of glass-ceramics provided according to the invention (FIGS. 10 and 11) and of known glass-ceramics (FIGS. 2 and 4 to 9) and, respectively, of a non-inventive glass-ceramic (FIG. 3). For better comparability, a spectrum of 6 ppm on the y-axis was again chosen for the representation in the FIGS.

FIGS. 2 to 8 show the thermal hysteresis curves of known/non-inventive materials that can be used for precision components. The cooling curves (dashed) and heating curves (dotted) are each clearly spaced apart from one another, specifically at lower temperatures, meaning that they have a clearly separate profile. At 15° C., the distance is more than 0.1 ppm, and up to around 1 ppm according to the comparative example. In other words, the materials and the precision components manufactured from them show considerable thermal hysteresis within the relevant temperature range from at least 15° to 35° C.

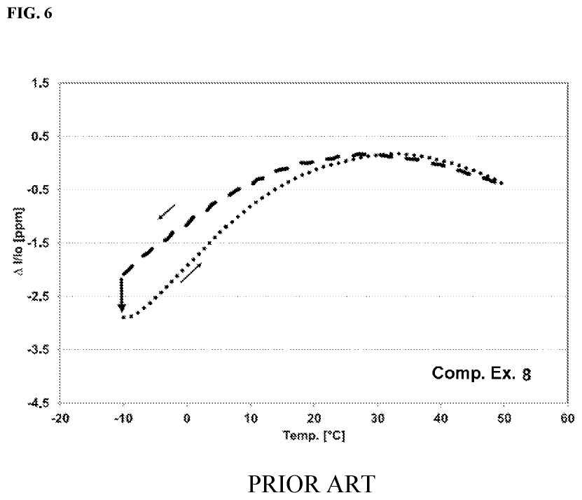

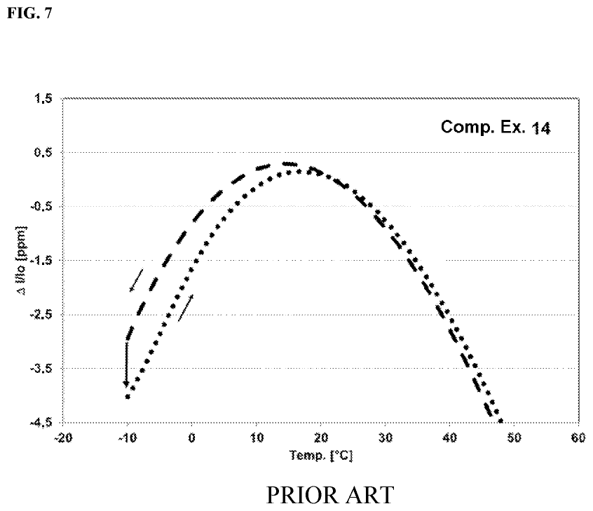

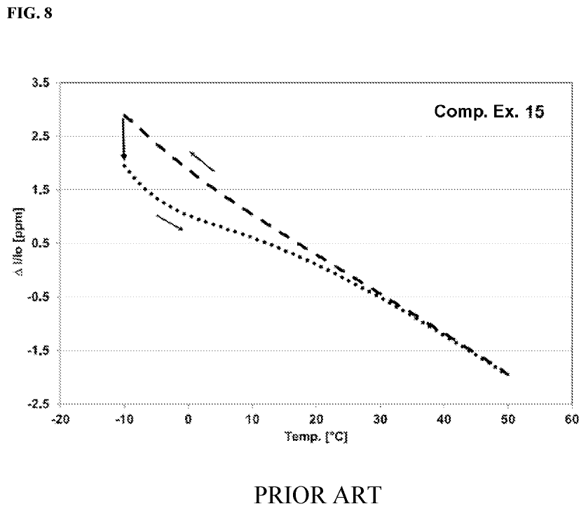

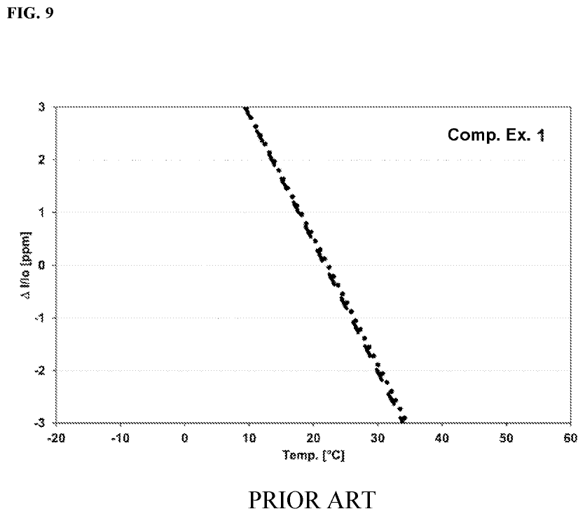

The LAS glass-ceramics analysed that are represented in FIGS. 2 to 5 (comparative examples 3, 9 and 10 in Table 2) all contain MgO and ZnO and also in most cases R₂O as well, and exhibit thermal hysteresis over wide ranges within the temperature interval of 15° C. to 35° C. FIGS. 6 and 7 show the hysteresis curves of LAS glass-ceramics (comparative examples 8 and 14 in Table 2), which are MgO-free but ZnO-containing. Below 19° C., both materials show significantly increasing thermal hysteresis. FIG. 8 shows the hysteresis curve of an LAS glass-ceramic (comparative example 15 in Table 2), which is ZnO-free but MgO-containing. This material likewise shows significantly increasing thermal hysteresis below 22° C. As is apparent from FIG. 9, this known material (comparative example 1 in Table 2) shows no thermal hysteresis, but the steep curve profile shows that it is not a zero-expansion material. The average CTE here is −0.24 ppm/K.

LAS glass-ceramics and precision components provided according to the invention have a defined content of the sum total of MgO+ZnO of >0.5 mol % to 1.5 mol % in combination with a defined R₂O content of more than 0.5 mol %. As is apparent from FIGS. 10 and 11, the heating curves and the cooling curves at least in the temperature range of 15° C. to 35° C. are situated over one another, meaning that the glass-ceramics are hysteresis-free. The materials, however, are hysteresis-free not only in the range of 15° C. to 35° C., but also at least in the range of 15 to 40° C. or 15 to 45° C.

Further Expansion Properties

Some embodiments provided according to the invention may have further advantageous expansion features:

For describing the expansion characteristics of a test specimen (glass-ceramic or precision component), a TCL value is frequently reported, with TCL meaning “total change of length”. Within the context of the invention, the TCL value is reported for the temperature range of 0° C. and 50° C. It is ascertained from the normalized Δl/l₀−T curve (also dl/l₀−T curve in the FIGS.) of the respective test specimen, with “normalized” meaning that the change in length at 0° C. is 0 ppm. The Δl/l₀−T curve for determining the TCL is created by the same method as described above in connection with the determination of CTE in the context of the invention.

The TCL value is the distance between the highest di/l₀ value and the lowest dl/l₀ value within this temperature range:

TCL (0;50° C.)=|dl/l₀ max.|+|dl/l₀ min.| (2)

where “dl” denotes the change in length at the respective temperature and “l₀” denotes the length of the test specimen at 0° C. The calculation is based in each case on the magnitudes of the dl/l₀ values.

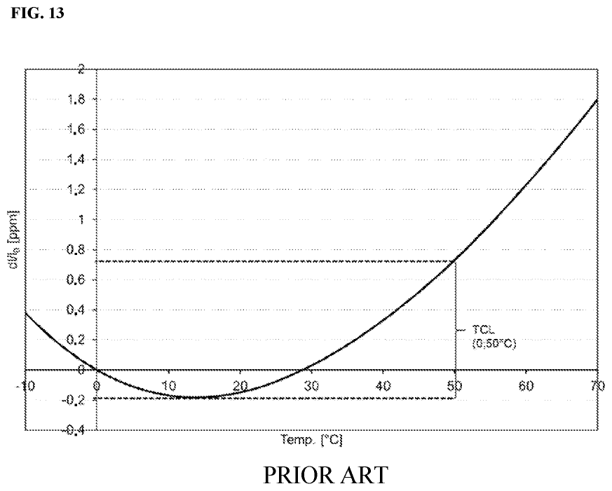

FIGS. 13 to 16 show expansion curves of known materials, from which the dl/l₀ max values and dl/10 min values can each be read off for calculating the TCL value (see also below). The expansion curves each show a curved profile in the temperature range of 0° C. to 50° C.

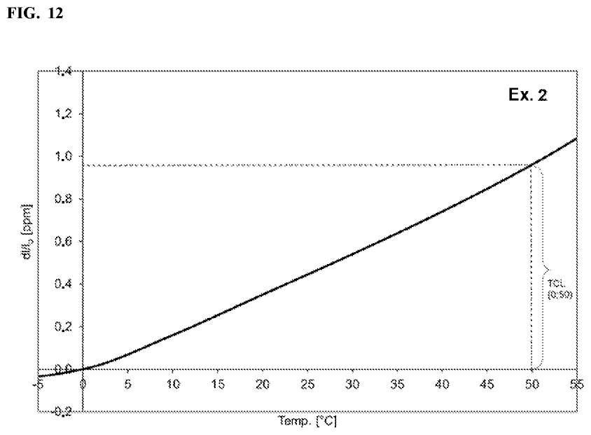

In the context of the present invention, by contrast, a flat profile of the expansion curve in the temperature range of 0° C. to 50° C. is an advantageous feature of the glass-ceramic and of a precision component (see FIG. 12). For some variants, depending on the field of use of the component, a flat profile of the expansion curve may also be desirable for another temperature range, especially in a range of (20;40), (20;70) and/or (−10;30).

As a statement as to the extent to which the curve profile of the thermal expansion differs from a simple linear profile, for some embodiments provided according to the invention the index F is introduced as a measure of the flatness of the expansion curve, so enabling a classification of CTE curves:

F=TCL (0;50° C.)|expansion (0;50° C.)| (3)

The index F is calculated by forming the quotient of the TCL (0;50) value [in ppm](see above) and the difference in expansion between the temperature points of 0° C. and 50° C. [in ppm]. Since the expansion curve for determining the TCL is by definition normalized in such a way that the change in length at 0° C. is 0 ppm, the “difference in expansion between the temperature points at 0° C. and 50° C.” corresponds to the “expansion at 50° C.”, as indicated in the tables. The index F is calculated using the magnitude of the expansion at 50° C.

It may be advantageous here if for the respective material or component, the index F is <1.20, optionally <1.15, optionally <1.10, optionally at most 1.05. The closer the index F is to 1, the flatter the expansion curve.

It is apparent from FIG. 12 that some embodiments of the LAS glass-ceramic have a flat profile of the expansion curve (here F=1), both in the temperature range of 0° C. to 50° C. and in a broader temperature range. In comparison to this, FIGS. 13 to 17 show that known materials exhibit a substantially steeper and curved profile of the expansion curves within the temperature ranges under consideration.

FIG. 12 shows, by way of example, the expansion curve of an exemplary glass-ceramic with reference to an advantageous ceramization of composition example 2. For the representation, a section of 1.6 ppm on the y-axis was chosen. The highest expansion value (dl/l₀ max) is at +50° C. (dl/l₀ is +0.96 ppm, i.e. 10.96 ppm|), the lowest expansion value (dl/l₀ min) is 0 ppm. The difference in expansion between the temperature points of 0° C. and 50° C., corresponding to the magnitude of the “expansion at 50° C.”, is 0.96 ppm. This is used to calculate the index F for this material as follows: F (example 2 from Table 1)=0.96 ppm/0.96 ppm=1.00.

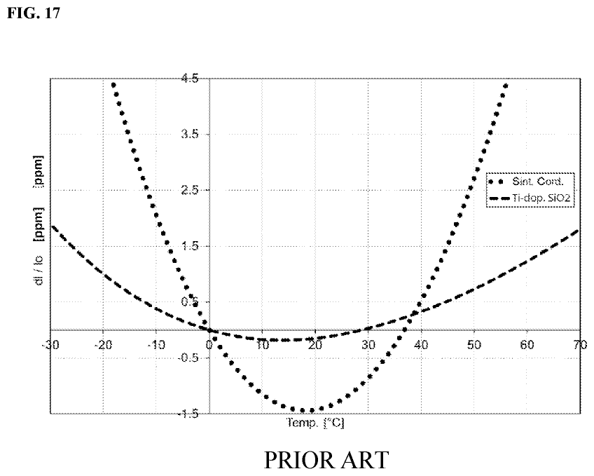

Some glass-ceramics and precision components provided according to the invention therefore have a very flat profile of their expansion curves, in the temperature range from 0° C. to 50° C., for example, meaning that in the temperature range under consideration they not only have zero expansion but also exhibit a low fluctuation in the change in lengthwise expansion and hence in the differential CTE in this range. As is apparent, for example, from FIG. 20, advantageous examples provided according to the invention also have a flat profile of their expansion curves over an even broader temperature range. See, by comparison, the substantially steeper profiles of the expansion curves of known materials based on the same temperature range in FIG. 17. The expansion characteristics can also be observed in other selected temperature ranges, especially (−10;30), (20;40), (20,70), as described later on below.

In comparison to the exemplary embodiments of the glass-ceramics and precision components provided according to the invention, FIGS. 13 to 17 show the expansion characteristics of known materials and precision components manufactured from them, and the index F can be calculated from each of these. The expansion characteristics of the materials or precision components, as represented in FIGS. 13 to 17, were ascertained using the same dilatometer under comparable conditions to the expansion characteristics of the embodiments of the glass-ceramics as represented in FIG. 12. Overall, the known materials show a curved profile of the expansion curves:

FIG. 13 shows the expansion curve of a commercially available titanium-doped quartz glass. As can be seen, the sum total of the magnitudes of the expansion value here at +50° C. (dl/l₀ max is +0.73 ppm, i.e. 10.73 ppm|) and of the expansion value at 14° C. (dl/10 min is −0.19 ppm, i.e. 10.19 ppm|) gives a TCL(0;50) value of around 0.92 ppm. The difference in expansion between the temperature points of 0° C. and 50° C., corresponding to the magnitude of the “expansion at 50° C.”, is 0.73 ppm. The index F for this material is calculated from this as follows: F (titanium-doped SiO₂)=0.92 ppm/0.73 ppm=1.26.

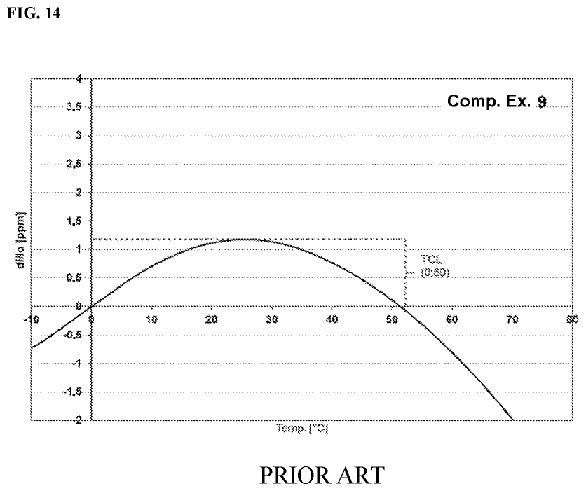

The index F is calculated correspondingly for a known LAS glass-ceramic and a corresponding precision component (see FIG. 14), as follows: F (known LAS glass-ceramic)=1.19 ppm/0.11 ppm=10.82.

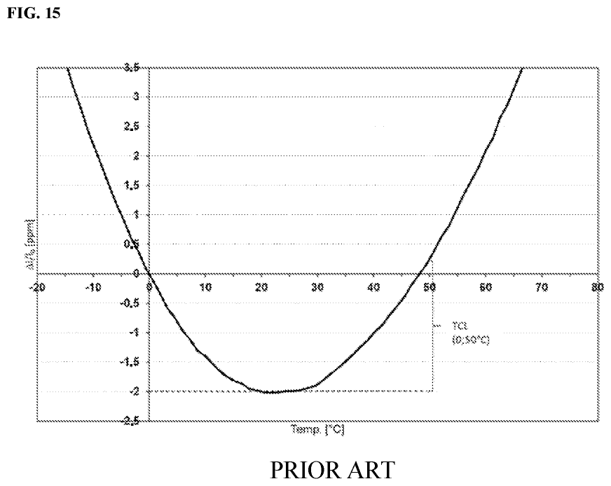

The index F is calculated correspondingly for a known cordierite glass-ceramic and a corresponding precision component (see FIG. 15), as follows: F (known cordierite glass-ceramic)=2.25 ppm/0.25 ppm=9.

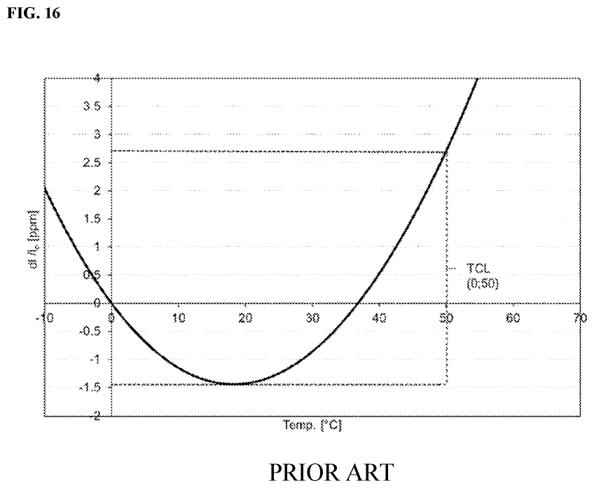

The index F is calculated correspondingly for a known sintered cordierite ceramic and a corresponding precision component (see FIG. 16), as follows: F (known sintered cordierite ceramic)=4.2 ppm/2.71 ppm=1.55.

Glass-ceramics with a flat profile of the expansion curves can be very advantageous, since it is then possible not just to optimize a precision component for the subsequent application temperature but also for it to have likewise low thermal expansion, for example, under relatively high and/or relatively low temperature loads, during production, for example. Precision components for microlithography, EUV microlithography (also “EUV lithography” or “EUVL” for short) and metrology are typically used under standard cleanroom conditions, in particular a room temperature of 22° C. The CTE may be matched to this application temperature. However, such components are subjected to various process steps, such as coating with metallic layers, and cleaning, structuring and/or exposure operations, for example, in which temperatures may be higher or in some cases lower than those prevailing in the case of subsequent use in a cleanroom. Glass-ceramics and precision components manufactured from them that have an index F of <1.20 and hence optimized zero expansion not just at application temperature but also at possibly higher and/or lower temperatures during production are therefore very advantageous. Properties such as freedom from hysteresis and an index F<1.20 may be particularly advantageous if the precision component or a glass-ceramic is used in EUV lithography, i.e. if, for example, the precision component is an EUVL mirror or EUVL mask blank or a corresponding substrate therefor, since the mirrors or masks in particular in EUV lithography become heated very nonuniformly at different points or in beam direction as a result of being irradiated with high-energy radiation. For such usage conditions, it is advantageous if the precision component or glass-ceramic exhibits a low slope of the CTE-T curve in a temperature range around the application temperature (see below).

A feature of glass-ceramics and precision components that are even better optimized to a later application temperature at 20 or 22° C. is that they have a relative change in length (dl/l₀) of ≤|0.10| ppm, optionally of <|0.09| ppm, optionally of <|0.08| ppm and optionally of 10.071 ppm in the temperature range from 20° C. to 30° C. and/or a relative change in length (dl/l₀) of <|0.17| ppm, optionally of |0.15| ppm, optionally of |0.13| ppm and optionally of ≤|0.11| ppm in the temperature range from 20° C. to 35° C.

Alternatively or additionally, a feature of such optimized glass-ceramics and precision components may be that they have a relative change in length (dl/l₀) of ≤|0.30| ppm, optionally of ≤|0.25| ppm, optionally of ≤10.201 ppm and optionally of ≤|0.15| ppm in the temperature range from 20° C. to 40° C. The features relating to the relative change in length based on the different temperature intervals may optionally be taken from the dl/l₀ curves of FIGS. 12 to 17. FIGS. for the relative change in length (dl/l₀) refer of course to the magnitude of the respective value.

A zero-expansion, hysteresis-free material having such advantageous expansion characteristics is particularly suitable for use as a substrate for an EUVL mirror or as an EUVL mirror which is heated to different degrees in operation, as a result for example of the respective exposure mask, in regions of light and shadow. On account of the above-stated low relative change in length, an EUVL mirror formed from the advantageous glass-ceramic has relatively low local gradients (or local slopes) in the topography of the mirror surface than an EUVL mirror manufactured using known materials. The same is applicable, analogously, to EUVL mask blanks or EUVL masks or EUVL photomasks.

Particularly in the case of a glass-ceramic which within the temperature range under consideration exhibits a very flat profile of the expansion curve, which is close to 0 ppm or fluctuates around 0 ppm—which constitutes advantageous expansion characteristics overall—it may be advantageous, alternatively or additionally to the index F, to introduce a further measure of the flatness of the expansion curve, in which the expansion curve is considered not in the temperature range of (0;50), but instead in a different temperature interval (T.i.), optionally in the temperature range of (20;40), (20;70) and/or (−10; 30). This allows the expansion characteristics to be classified in relation to the later fields of application.

The alternative index f_{T.i.} has the unit (ppm/K) and is defined as:

f_{T.i.}=TCL_{(T.i.)}/width of the temperature interval (T.i.) (4)

where T.i. describes the temperature interval under consideration in each case.

The TCL_{(T.i)} value is the distance between the highest dl/l₀ value and the lowest dl/l₀ value within the temperature range (T.i.) under consideration in each case, where the expansion curve for the determination of TCL_{(T.i.)} as well is by definition normalized in such a way that the change in length at 0° C. is 0 ppm. In other words, for example:

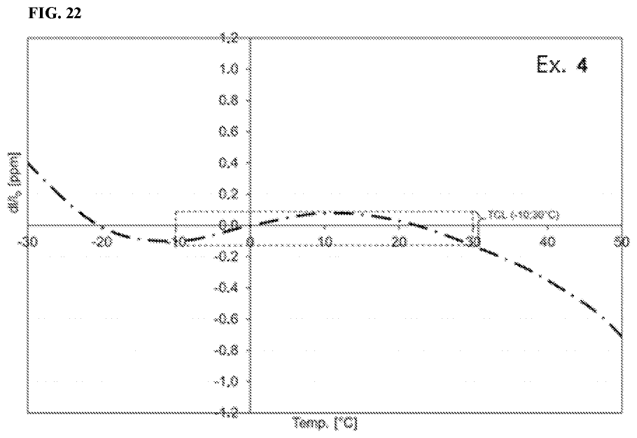

TCL_{(20;40° C.)}=|dl/l₀ max.|+|dl/l₀ min.| (5)

where “dl” denotes the change in length at the respective temperature and “l₀” denotes the length of the test specimen at 0° C. The calculation is based in each case on the magnitudes of the dl/l₀ values when the curve fluctuates around zero in the temperature interval under consideration (e.g. FIG. 22).

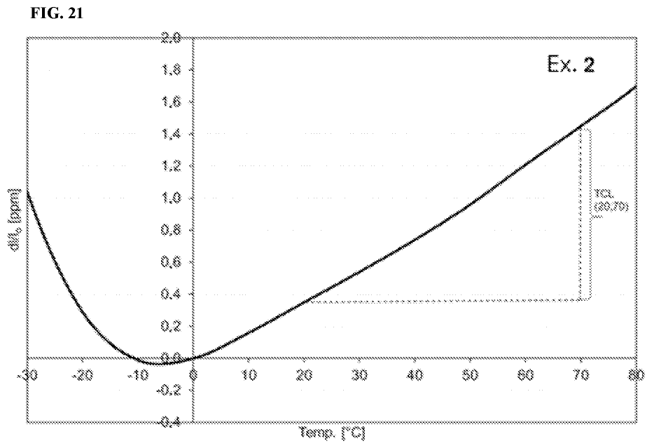

Otherwise, the TCL_{(T.i.)} is the distance ascertained from the difference between the highest dl/l₀ value and the lowest dl/l₀ value within the temperature interval (T.i.) under consideration in each case, this being self-evident and apparent from the FIGS. (e.g. FIGS. 20, 21). The TCL_{(T.i.)}, expressed generally, may be calculated as follows:

TCL_{(T.i.)}=dl/l₀ max.−dl/l₀ min. (6)

The alternative index f_{T.i.} is calculated according to formula (4) by forming the quotient from the TCL_{(T.i.)} value [in ppm] (see above) and the width of the temperature interval (T.i.) reported in [K] in which the difference in expansion is being considered. The width of the temperature interval considered between 20° C. and 40° C. is 20K. If, in contrast, the profile of the expansion curve is considered in the interval T.i.=(20;70) or (−10;30), the divisor for formula (4) is 50K or 40K, respectively.

In some embodiments, the glass-ceramic has an alternative index f_{(20;40)}<0.024 ppm/K and/or an alternative index f_{(20;70)}<0.039 ppm/K and/or an alternative index f_{(-10;30)}<0.015 ppm/K.

Glass-ceramics having a very flat profile of the expansion curves may be very advantageous, since it is then possible to optimize a precision component not only for the later application temperature but also, for example, for higher and/or lower temperature loads that can be expected. The alternative index f_{T.i.} is suitable for defining a suitable material in accordance with the specifications required for particular component applications, and for providing a corresponding precision component. Specific precision components and their applications are described later on below and are included here as well.

According to some embodiments of the glass-ceramic or a component produced from it, it may be advantageous if the alternative index f_{(20;40)} is <0.024 ppm/K, optionally <0.020 ppm/K, optionally <0.015 ppm/K. A hysteresis-free, zero-expansion component having such expansion characteristics in the temperature range of (20;40) has particularly good usability as a precision component for microlithography and EUV microlithography at room temperature. One example of a glass-ceramic of this kind is represented in FIG. 20.

According to some embodiments of the glass-ceramic or a component produced from it, it may be advantageous if the alternative index f_{(20;70)} is <0.039 ppm/K, optionally <0.035 ppm/K, optionally <0.030 ppm/K, optionally <0.025 ppm/K, optionally <0.020 ppm/K. A hysteresis-free, zero-expansion component having such expansion characteristics in the temperature range of (20;70) likewise has particularly good usability as a precision component for microlithography and EUV microlithography. It may be advantageous if the component has an equally low thermal expansion at higher temperature loads as well, as may occur, for example, during the production of the precision component, but also locally or over an area in operation. Further details of the temperature loads that occur in the context of EUVL precision components have already been described above in connection with the index F, to which reference is made here for avoidance of repetitions. One example of a glass-ceramic of this kind is represented in FIG. 21.

According to some embodiments of the glass-ceramic or a component produced from it, it may be advantageous if the alternative index f_{(-10;30)} is <0.015 ppm/K, optionally <0.013 ppm/K, optionally <0.011 ppm/K. A hysteresis-free, zero-expansion component having such expansion characteristics in the temperature range of (−10;30) has particularly good usability as a precision component, more particularly as mirror substrates for applications in which temperatures lower than room temperature are among those which may occur; for example, as mirror substrates in astronomy or in Earth observation from space. Corresponding components are described later on below. One example of a glass-ceramic of this kind is represented in FIG. 22.

One exemplary embodiment of a glass-ceramic or a component produced from it has an expansion curve for which at least 2 of the alternative indices f_{(T.i.)} are applicable.

One exemplary embodiment of a glass-ceramic or a component produced from it has an expansion curve for which the index F and at least one of the alternative indices f_{(T.i.)} are applicable.

FIG. 18 shows exemplary advantageous configurations of the LAS glass-ceramic and of the precision component have a CTE “plateau”. A glass-ceramic having a plateau, i.e. having optimized zero expansion over a broad temperature range, offers the same advantages as have already been described above in connection with the flat profile of the expansion curves and of the index F.

It may be advantageous if the differential CTE has a plateau close to 0 ppm/K, meaning that the differential CTE in a temperature interval T_{P} having a width of at least 40 K, optionally at least 50 K, is less than 0±0.025 ppm/K. The temperature interval of the CTE plateau is defined as T_{P}. Optionally, the differential CTE in a temperature interval T_{P} having a width of at least 30 K or at least 40 K may be less than 0±0.015 ppm/K.

A CTE “plateau” is thus understood to mean a region extending over a section of the CTE-T curve, in which the differential CTE does not exceed a value of 0±0.025 ppm/K, optionally 0±0.015 ppm/K, optionally 0±0.010 ppm/K, optionally 0±0.005 ppm/K, i.e. a CTE close to 0 ppb/K.

Optionally, the differential CTE in a temperature interval T_{P} having a width of at least 30 K or at least 40 K may be less than 0±0.015 ppm/K, i.e. 0±15 ppb/K. In some embodiments, a CTE plateau of 0±0.01 ppm/K, i.e. 0±10 ppb/K, may be formed over a temperature interval of at least 20 K or at least 30 K or at least 40 or at least 50 K. In FIG. 18, the curve between −5° C. and 15° C., i.e. over a width of around 20 K, in fact shows a CTE plateau of 0±0.005 ppm/K, i.e. 0±5 ppb/K.

It may be advantageous if the temperature interval T_{P} is in a range from −10 to +100° C., optionally 0 to 80° C.

The position of the CTE plateau of the glass-ceramic is optionally matched to the application temperature T_{A} of the precision component. Exemplary application temperatures T_{A} are in the range of −60° C. to +100° C., optionally from −40° C. to +80° C. Particular variants of the present invention relate to precision component and glass-ceramics for application temperatures T_{A} of 0° C., 5° C., 10° C., 22° C., 40° C., 60° C., 80° C. and 100° C. The CTE plateau, i.e. the region of the curve that has the low deviation of the differential CTE in the temperature interval T_{y}, may also be situated in the temperature range of [−10;100]; [0;80], [0; 30° C.], [10; 40° C.], [20; 50° C.], [30; 60° C.], [40; 70° C.] and/or [50; 80° C.]. In some glass-ceramics and precision components, the CTE plateau may also be situated in the temperature range of [−10;30], [0;50], [19:25° C.]; [20;40] and/or [20;70].

According to some embodiments provided according to the invention, the CTE-T curve of the glass-ceramic or precision component in a temperature interval which has at least a width of 30 K, optionally at least a width of 40 K, optionally at least a width of 50 K, has at least one section of curve with low slope, more particularly a slope of at most 0±2.5 ppb/K², optionally of at most 0±2 ppb/K², optionally of at most 0±1.5 ppb/K², optionally of at most 0±1 ppb/K², optionally of at most 0±0.8 ppb/K², and even, according to some variants, of at most 0±0.5 ppb/K².

The temperature interval with low slope is optionally adapted to the application temperature T_{A} of the precision component. Exemplary application temperatures T_{A} are in the range of −60° C. to +100° C., optionally of −40° C. to +80° C. Some variants of the present invention relate to glass-ceramics and precision component for application temperatures T_{A} of 0° C., 5° C., 10° C., 22° C., 40° C., 60° C., 80° C. and 100° C. The temperature interval with low slope may also be situated in the temperature range of [−10;100], [0;80], [0; 30° C.], [10; 40° C.], [20; 50° C.], [30; 60° C.], [40; 70° C.] and/or [50; 80° C.]. In further exemplary glass-ceramics and precision components, the temperature interval with low slope may also be situated in the temperature range of [−10;30], [0;50], [19:25° C.], [20;40] and/or [20;70].

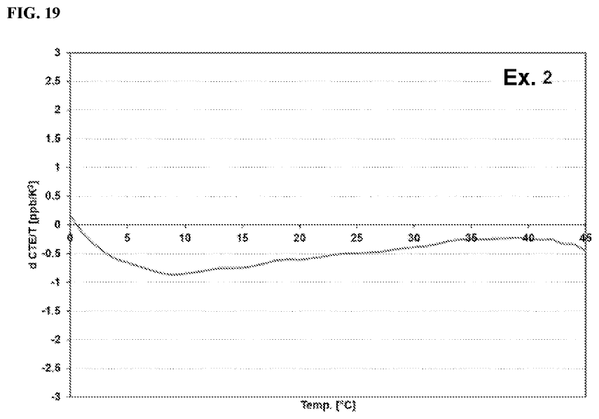

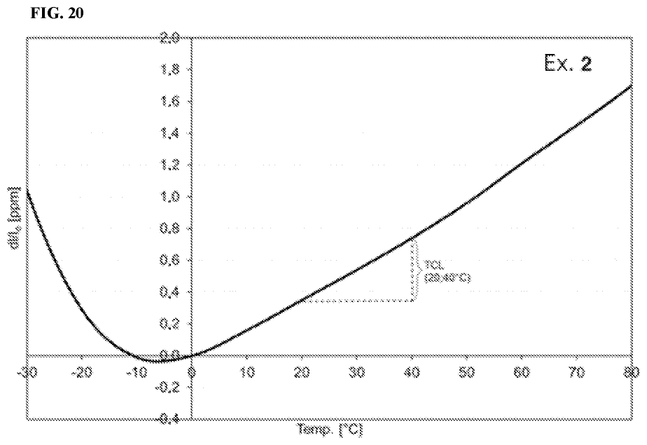

FIG. 19 shows the slope of the CTE-T curve in the temperature range from 0° C. to 45° C. for a glass-ceramic or precision component on the basis of the composition of example 2 from Table 1. The CTE slope is below 0±1 ppb/K² in the entire temperature range, and in an interval of at least 20 K width is in fact below 0±0.5 ppb/K².

Glass-ceramics and precision components having such expansion characteristics are especially readily suitable for EUV lithography applications (e.g. as mirrors or substrates for mirrors or masks or mask blanks), since in this range the requirements with regard to the materials and precision components used for the optical components are becoming increasingly high in relation to extremely low thermal expansion, a zero crossing of the CTE-T curve close to the application temperature, and, in particular, to a low slope of the CTE-T curve. In the context of the invention, some advantageous configurations of a glass-ceramic or precision component have a very flat CTE profile, with the profile exhibiting not only a zero crossing but also a very low CTE slope and possibly a very flat plateau.

The feature of the low slope may be present with or without development of an advantageous CTE plateau.

By varying the ceramization temperature and/or ceramization time, it is possible to adapt the expansion curves and/or the CTE profile to different application temperatures. For example, the zero crossing of the CTE-T curve may thus be shifted by raising or lowering the ceramization temperature, or the expansion curve can be adjusted. Alternatively, for increasing or lowering the ceramization temperature, it is also possible to respectively extend or shorten the ceramization time correspondingly.

Some advantageous glass-ceramics and precision components additionally have good internal quality. They optionally have at most 5 inclusions per 100 cm³, optionally at most 3 inclusions per 100 cm³, optionally at most 1 inclusion per 100 cm³. Inclusions are understood in accordance with the invention to refer both to bubbles and to crystallites having a diameter of more than 0.3 mm.

According to some embodiments, precision components are provided which have a diameter or an edge length of at most 800 mm and a thickness of at most 100 mm and have at most 5, optionally at most 3, optionally at most 1 inclusion(s), in each case per 100 cm³, having a diameter of a size of more than 0.03 mm.

As well as the number of inclusions, the maximum diameter of the inclusions detected also serves as a measure of the level of the internal quality. The maximum diameter of individual inclusions within the total volume of a precision component having a diameter of less than 500 mm or edge lengths of less than 500 mm is optionally at most 0.6 mm, in the critical volume for the application, for example close to the surface, optionally at most 0.4 mm. The maximum diameter of individual inclusions in glass-ceramic components having a diameter of 500 mm to less than 2 m or edge lengths of 500 mm to less than 2 m is optionally at most 3 mm, in the volume critical for the application, for example close to the surface, optionally at most 1 mm. This may be advantageous in order to achieve the surface quality needed for the application.

The invention relates further to the use of a glass-ceramic provided according to the invention in a precision component. The glass-ceramic may, for example, form a substrate for the precision component.

Further, the invention relates to the use of an LAS glass-ceramic provided according to the invention in a precision component more particularly for use in metrology, spectroscopy, measurement technology, lithography, astronomy or Earth observation from space, for example as mirror or mirror carrier for segmented or monolithic astronomical telescopes or else as weight-reduced or ultra-light mirror substrates for, for example, space-based telescopes or as high-precision structure components for measurement of distance, for example in space, or optics for Earth observation, as precision components, such as standards for precision measurement technology, precision rules, reference plates in interferometers, as mechanical precision parts, for example for ring laser gyroscopes, spiral springs for the clock industry, as for example mirrors and prisms in LCD lithography, and for example as mask holders, wafer stages, reference plates, reference frames and grid plates in microlithography and in EUV (extreme UV) microlithography, and additionally as mirrors or mirror substrates and/or photomask substrates or photomask blanks or reticle mask blanks in EUV microlithography.

A glass-ceramic provided according to the invention may be used to produce precision components in different sizes:

Some embodiments relate to precision components having relatively small dimensions, more particularly in the case of (rect)angular shapes with edge lengths (width and/or depth) or in the case of round areas having diameters of at least 50 mm, optionally at least 100 mm and/or not more than 1500 mm, optionally not more than 1000 mm and/or a thickness of less than 50 mm, optionally less than 10 mm and/or at least 1 mm, optionally at least 2 mm. Such precision components may be employed, for example, in microlithography and EUV lithography.

Some embodiments concern precision components having very small dimensions, more particularly having edge lengths (width and/or depth) or diameters and/or thickness of a few mm (for example at most 20 mm or at most 10 mm or at most 5 mm or at most 2 mm or at most 1 mm) to a few tenths of a mm (for example at most 0.7 mm or at most 0.5 mm). These precision elements may be, for example, a spacer, for example in an interferometer, or a component for ultra-stable clocks in quantum technology.

It is alternatively possible to produce very large precision components. Some embodiments provided according to the invention thus relate to components of high volume. In the context of this application, this term is taken to mean a component having a mass of at least 300 kg, optionally at least 400 kg, optionally at least 500 kg, optionally at least 1 t, optionally at least 2 t, according to some variants provided according to the invention at least 5 t, and/or having edge lengths (width and/or depth) in the case of (rect)angular shapes of at least 0.5 m, optionally at least 1 m, and/or with a thickness (height) of at least 50 mm, optionally at least 100 mm, optionally at least 200 mm, optionally at least 250 mm, or, in the case of round shapes, having a diameter of at least 0.5 m, optionally at least 1 m, optionally at least 1.5 m and/or having a thickness (height) of at least 50 mm, optionally at least 100 mm, optionally at least 200 mm, optionally at least 250 mm.

Some embodiments provided according to the invention may also be even larger components, having, for example, a diameter of at least 3 m or at least 4 m or greater and/or a thickness of 50 mm to 400 mm, optionally 50 mm to 300 mm. According to some embodiments, the invention also relates to rectangular components, where optionally at least one surface has an area of at least 1 m², optionally at least 1.2 m², optionally at least 1.4 m², for certain variants optionally at least 3 m² or at least 4 m², and/or the thickness is 50 mm to 400 mm, optionally 50 mm to 300 mm. Generally speaking, large-volume components are produced that have a significantly greater base area than height. However, the large-volume components in question may also be those which have a shape approximated to a cube or a sphere.

Precision components may be, for example, optical components, specifically what is called a normal-incidence mirror, i.e. a mirror which is operated close to the perpendicular impingement of radiation, or what is called a grazing-incidence mirror, i.e. a mirror which is operated at the grazing impingement of radiation. Such a mirror comprises not only the substrate but also a coating that reflects the incident radiation. Especially in the case of a mirror for x-radiation, the reflective coating is, for example, a multilayer system or multilayer having a multiplicity of layers of high reflectivity in the x-ray range in the case of non-grazing incidence. A multilayer system of this kind for a normal-incidence mirror optionally comprises 40 to 200 pairs of layers, consisting of alternating layers of, for example, one of the material pairings Mo/Si, Mo/Bi, Ru/Si and/or MoRu/Be.

In particular, the optical elements provided according to the invention may be x-ray-optical elements, i.e. optical elements that are used in conjunction with x-radiation, more particularly soft x-radiation or EUV radiation, and more particularly photomasks or reticle masks that are operated in reflection, especially for EUV microlithography. This may be mask blanks. With further advantage, the precision component can be used as a mirror for EUV lithography or as a substrate for a mirror for EUV lithography.

The precision component provided according to the invention may further be a component, especially a mirror, for astronomical applications. Such components for use in astronomy may be employed here either terrestrially or in space. High-precision structure components for measurements of distance, in space for example, are a further advantageous field of application.

The precision component provided according to the invention may be a lightweight structure. The component provided according to the invention may further comprise a lightweight structure. This means that in certain regions of the component, cavities are provided for reducing the weight. As a result of lightweight working, the weight of a component is reduced optionally by at least 80%, optionally at least 90%, by comparison with the unworked component.

A further subject provided according to the invention is a precision component which comprises an LAS glass-ceramic provided according to the invention. Details in this regard have already been described above in connection with the glass-ceramic and the use thereof in precision components. This disclosure is incorporated fully into the description of the precision component.

It will be appreciated that the features provided according to the invention that have been stated above and those still to be elucidated hereinafter can be used not only in the combination specified in each case but also in other combinations without leaving the scope of the invention.

### Examples

Tables 1 and 2 show compositions of examples of glass-ceramics provided according to the invention and compositions of comparative examples, and their properties.

The compositions stated in Table 1 were melted from commercial raw materials, such as oxides, carbonates and nitrates in customary production processes. The green glasses produced according to Table 1 were first ceramized at the maximum temperature specified in each case, over the specific time.

The production of a glass-ceramic for a precision component, more particularly a large precision component, is described for example in WO 2015/124710 A1.

Table 1 shows 4 examples (Ex.) provided according to the invention which are hysteresis-free at least in a temperature range of 15° C. to 35° C. and have zero expansion. Examples 1 to 4 exhibit thermal hysteresis below around 15° C. Moreover, the index F is <1.20, i.e. the profile of the expansion curve in the temperature range of 0° C. to 50° C. is advantageously flat for all the examples. Furthermore, the examples have a processing temperature <1330° C., allowing the glass-ceramics to be produced with high homogeneity in industrial-scale production plants. The processing temperatures as reported in Tables 1 and 2 were ascertained in accordance with DIN ISO 7884-1 (2014—source: Schott Techn. Glas-Katalog).

In the case of example 1, after ceramization at not more than 815° C. over the time of 2.5 days, the average CTE was determined for further temperature intervals, with the following result: CTE (20; 300° C.): 0.39 ppm/K, CTE (20; 500° C.): 0.68 ppm/K, CTE (20; 700° C.): 0.94 ppm/K.

Table 2 shows comparative examples (Comp. Ex.). Comparative examples 1 and 2 contain neither MgO nor ZnO, but the average CTE(0;50) is greater than 0±0.1×10⁻⁶/K, i.e. these comparative examples do not have zero expansion. Furthermore, comparative examples 1 and 2 have a processing temperature >1330° C. These materials are very viscous, and so it is not possible to use them to manufacture components of high homogeneity in industrial-scale production plants.

Comparative examples 3 and 7 to 16 all contain MgO and/or ZnO, and most of them have zero expansion. However, these comparative examples, at least in the temperature range of 15° C. to 35° C., exhibit a thermal hysteresis of substantially more than 0.1 ppm. At room temperature, i.e. 22° C., this group of comparative examples has thermal hysteresis, except for comparative examples 14 and 16. Comparative example 9, although it has zero expansion, additionally has an unadvantageously steep profile of the expansion curve in the temperature range of 0° C. to 50° C., as evident from the high value for the index F. Comparative example 3 features a comparatively low sum total of MgO+ZnO, but contains no R₂O. In the 15° C. to 35° C. temperature range at least it has a thermal hysteresis of substantially more than 0.1 ppm. Moreover, the expansion curve is sharply curved, as evident from the high value for the index F.

Empty fields in the tables below for the details concerning the composition mean that this/these component(s) was/were not added deliberately or is/are not present.

For two examples provided according to the invention and one comparative example, Table 3 shows the calculated alternative index f_{(T.i.)} for different temperature intervals, from which it is apparent that the expansion curves of the examples in the temperature ranges defined each have a flatter profile than the comparative example.

It will be clear to experts that—depending on the application temperature of the glass-ceramic or of the precision component comprising the glass-ceramic—the glass-ceramic chosen is one having the desired properties, especially in terms of the thermal hysteresis and/or average CTE.

TABLE 1
Compositions, ceramization and properties (mol %)

| Example | | | | |
|---|---|---|---|---|
| No. (Ex.) | 1 | 2 | 3 | 4 |
| Li₂O | 8.7 | 9.3 | 9.35 | 8.1 |
| Na₂O | 0.30 | 0.75 | 0.60 | 0.30 |
| K₂O | 1.00 | 0.45 | 1.20 | 0.45 |
| MgO | | 0.75 | 0.55 | 0.30 |
| ZnO | 0.70 | | 0.30 | 0.50 |
| CaO | 1.60 | 1.25 | | 2.10 |
| BaO | 0.55 | | | 0.2 |
| SrO | | | | 0.2 |
| Al₂O₃ | 17.0 | 18.5 | 14.7 | 15.2 |
| SiO₂ | 67.15 | 62.5 | 67.1 | 68.15 |
| P₂O₅ | | 3.4 | 3.0 | 1.55 |
| TiO₂ | 1.85 | 1.9 | 2.0 | 1.85 |
| ZrO₂ | 0.95 | 1.0 | 1.0 | 0.9 |
| Sb₂O₃ | 0.2 | 0.2 | | |
| As₂O₃ | | | 0.2 | 0.2 |
| Total | 100.0 | 100.0 | 100.0 | 100.0 |
| SiO₂ + (5xLi₂O) | 110.65 | 109.00 | 113.85 | 108.70 |
| MgO + ZnO | 0.70 | 0.75 | 0.85 | 0.80 |
| ΣR₂O | 1.30 | 1.20 | 1.80 | 0.75 |
| (R = Na, K, Cs, Rb) | | | | |
| ΣRO (R = Ca, Ba, Sr) | 2.15 | 1.25 | | 2.55 |
| Va (=T4) [° C.] | 1269 | | 1307 | 1298 |
| T3 [° C.] | 1436 | | 1488 | 1472 |
| Ceram. temperature | 815° C. | 815° C. | 810° C. | 810° C. |
| [° C.] | | | | |
| Ceram. time [days] | 2.5 | 2.5 | 2.5 | 2.5 |
| Cryst. phase [vol %] | 55 | 64 | 63 | 62 |
| Cryst. size [nm] | 51 | 55 | 47 | 44 |
| Av. CTE(0; +50° C.) | −0.07 | 0.02 | −0.06 | −0.015 |
| [ppm/K] | | | | |
| TCL (0; +50° C.) | 3.49 | 0.96 | 2.89 | 0.79 |
| \|Expansion at 50° C.\| | 3.49 | 0.96 | 2.89 | 0.73 |
| Index F | 1.00 | 1.00 | 1.00 | 1.08 |
| Hyst @ 45° C. [ppm] | <0.1 | <0.1 | <0.1 | <0.1 |
| Hyst @ 35° C. [ppm] | <0.1 | <0.1 | <0.1 | <0.1 |
| Hyst @ 30° C. [ppm] | <0.1 | <0.1 | <0.1 | <0.1 |
| Hyst @ 22° C. [ppm] | <0.1 | <0.1 | <0.1 | <0.1 |
| Hyst @ 19° C. [ppm] | <0.1 | <0.1 | <0.1 | <0.1 |
| Hyst @ 15° C. [ppm] | <0.1 | <0.1 | <0.1 | <0.1 |
| Hyst @ 10° C. [ppm] | 0.1 | 0.13 | 0.1 | 0.15 |
| Hyst @ +5° C. [ppm] | 0.13 | 0.20 | 0.11 | 0.25 |
| Hyst @ 0° C. [ppm] | 0.21 | 0.30 | 0.18 | 0.38 |
| Ceram. temperature | 815° C. | 815° C. | 810° C. | 810° C. |
| [° C.] | | | | |
| Ceram. time [days] | 2.5 | 2.5 | 2.5 | 2.5 |
| Av. CTE | −0.10 | 0.004 | −0.06 | −0.03 |
| (−30; +70° C.)[ppm/K] | | | | |
| Av. CTE | −0.10 | −0.005 | −0.10 | −0.05 |
| (−40; +80° C.)[ppm/K] | | | | |

TABLE 2
Compositions, ceramization and properties (mol %)

| | Comparative example No. | | |
|---|---|---|---|
| | (Comp. Ex.) | | |
| | 1 | 2 | 3 |
| Li₂O | 8.1 | 9.15 | 8.15 |
| Na₂O | 0.4 | 0.4 | |
| K₂O | 0.15 | 0.2 | |
| MgO | | | 0.45 |
| ZnO | | | 0.30 |
| CaO | 4.15 | | 2.1 |
| BaO | | 0.6 | 0.95 |
| SrO | | | |
| Al₂O₃ | 12.45 | 14.2 | 15.35 |
| SiO2 | 72.3 | 71.7 | 68.15 |
| P₂O₅ | | 0.62 | 1.5 |
| TiO₂ | 1.3 | 1.75 | 1.85 |
| ZrO₂ | 1.0 | 1.2 | 0.95 |
| As2O₃ | 0.15 | 0.15 | 0.25 |
| Total | 100.0 | 100.0 | 100.0 |
| SiO₂ + (5xLi₂O) | | | 108.90 |
| MgO + ZnO | | | 0.75 |
| ΣR₂O (R = Na, K, Cs, Rb) | 0.55 | 0.6 | 0 |
| ΣRO (R = Ca, Ba, Sr) | 4.15 | 0.6 | 3.05 |
| Va [° C.] | 1345 | 1340 | 1295 |
| Ceram. temperature [° C.] | 760 | | 790° C. |
| Ceram. time [days] | 10 | | 2.5 |
| Cryst. phase [vol %] | 60 | | 63 |
| Cryst. size [nm] | 63 | | 39 |
| Av. CTE(0; +50° C.) [ppm/K] | −0.25 | | −0.006 |
| TCL (0; +50° C.) | | | 0.62 |
| \|Expansion at 50° C.\| | | | 0.28 |
| Index F | | | 2.21 |
| Hyst @ 45° C. [ppm] | | | <0.1 |
| Hyst @ 35° C. [ppm] | | | <0.1 |
| Hyst @ 30° C. [ppm] | | | 0.11 |
| Hyst @ 22° C. [ppm] | <0.1 | | 0.15 |
| Hyst @ 19° C. [ppm] | <0.1 | | |
| Hyst @ 15° C. [ppm] | <0.1 | | 0.23 |
| Hyst @ 10° C. [ppm] | <0.1 | | 0.33 |
| Hyst @ +5° C. [ppm] | <0.1 | | 0.48 |
| Hyst @ 0° C. [ppm] | 0.13 | | |
| Ceram. temperature [° C.] | | | |
| Ceram. time [days] | | | |
| Av. CTE (−30; +70° C.)[ppm/K] | | | |
| Av. CTE (−40; +80° C.)[ppm/K] | | | |

| | Comparative example No. | | | | | |
|---|---|---|---|---|---|---|
| | (Comp. Ex.) | | | | | |
| | 7 | 8 | 9 | 10 | 11 | 12 |
| Li₂O | 8.5 | 7.78 | 9.32 | 9.2 | 9.4 | 9.0 |
| Na₂O | 0.1 | 0.8 | | 0.1 | 0.2 | 0.1 |
| K₂O | 0.5 | | | | | |
| MgO | 1.8 | | 1.2 | 1.6 | 1.2 | 1.6 |
| ZnO | 1.3 | 1.8 | 0.4 | 0.6 | 0.6 | 0.4 |
| CaO | | 2.42 | 1.0 | 1.2 | 1.0 | 1.3 |
| BaO | | 1.07 | 0.36 | 0.4 | 0.3 | 0.5 |
| SrO | | | | | | |
| Al₂O₃ | 16.9 | 15.39 | 19.11 | 16.2 | 19.0 | 16.4 |
| SiO₂ | 64.3 | 65.42 | 61.4 | 63.3 | 61.4 | 63.9 |
| P₂O₅ | 3.4 | 2.47 | 3.97 | 3.8 | 3.9 | 3.5 |
| TiO₂ | 1.9 | 1.67 | 1.92 | 2.2 | 1.9 | 2.1 |
| ZrO₂ | 1.1 | 0.92 | 1.07 | 1.1 | 1.1 | 1.2 |
| As₂O₃ | 0.2 | 0.26 | 0.25 | 0.2 | 0.2 | 0.1 |
| Total | 100.0 | 100.0 | 100.0 | 100.0 | 100.0 | 100.1 |
| SiO₂ + (5xLi₂O) | | | | | | |
| MgO + ZnO | 3.1 | 1.8 | 1.6 | 2.2 | 1.8 | 2.0 |
| ΣR₂O (R = Na, K, Cs, Rb) | 0.6 | 0.8 | | 0.1 | 0.2 | 0.1 |
| ΣRO (R = Ca, Ba, Sr) | | 3.49 | 1.36 | 1.6 | 1.3 | 1.8 |
| Va [° C.] | | | | | | |
| Ceram. temperature [° C.] | 810 | | | 760 | 810 | 760 |
| Ceram. time [days] | 10 | | | 10 | 5 | 10 |
| Cryst. phase [vol %] | 76 | | | | | |
| Cryst. size [nm] | 72 | | | | | |
| Av. CTE(0; +50° C.) [ppm/K] | 0.03 | 0.02 | 0.002 | −0.15 | 0.03 | −0.05 |
| TCL (0; +50° C.) | | | 1.19 | 3.68 | 1.32 | 0.35 |
| \|Expansion at 50° C.\| | | | 0.11 | 3.68 | 1.28 | 0.35 |
| Index F | | | 10.82 | 1.00 | 1.03 | 1.00 |
| Hyst @ 45° C. [ppm] | 0.11 | <0.1 | <0.1 | <0.1 | <0.1 | <0.1 |
| Hyst @ 35° C. [ppm] | 0.14 | <0.1 | 0.12 | <0.1 | <0.1 | <0.1 |
| Hyst @ 30° C. [ppm] | 0.18 | <0.1 | 0.16 | <0.1 | 0.1 | 0.11 |
| Hyst @ 22° C. [ppm] | 0.27 | 0.14 | 0.24 | 0.14 | 0.16 | 0.17 |
| Hyst @ 19° C. [ppm] | | | | | | |
| Hyst @ 15° C. [ppm] | | | | | | |
| Hyst @ 10° C. [ppm] | 0.61 | 0.42 | 0.54 | 0.38 | 0.85 | 0.43 |
| Hyst @ +5° C. [ppm] | 0.85 | 0.61 | 0.74 | 0.56 | 0.61 | 0.61 |
| Hyst @ 0° C. [ppm] | 1.1 | 0.81 | 0.92 | 0.76 | 0.85 | 0.82 |
| Ceram. temperature [° C.] | | | | | | |
| Ceram. time [days] | | | | | | |
| Av. CTE (−30; +70° C.)[ppm/K] | | | | | | |
| Av. CTE (−40; +80° C.)[ppm/K] | | | | | | |

| | Comparative example No. | | | |
|---|---|---|---|---|
| | (Comp. Ex.) | | | |
| | 13 | 14 | 15 | 16 |
| Li₂O | 8.4 | 8.2 | 9.4 | 9.3 |
| Na₂O | 0.05 | 0.35 | 0.1 | 0.25 |
| K₂O | | | 0.6 | 0.25 |
| MgO | | | 1.8 | |
| ZnO | 0.95 | 1.2 | | 0.60 |
| CaO | 2.3 | 2.35 | | 1.0 |
| BaO | | | | 0.85 |
| SrO | | | | |
| Al₂O₃ | 16.55 | 16.5 | 17 | 18.95 |
| SiO₂ | 65.15 | 64.8 | 64.4 | 61.5 |
| P₂O₅ | 3.4 | 3.3 | 3.5 | 4.05 |
| TiO₂ | 2.0 | 2.0 | 1.95 | 2.05 |
| ZrO₂ | 1.1 | 1.1 | 1.05 | 1.05 |
| As₂O₃ | 0.15 | 0.2 | 0.2 | 0.15 |
| Total | 100.0 | 100.0 | 100.0 | 100.0 |
| SiO₂ + (5xLi₂O) | | | | |
| MgO + ZnO | 0.95 | 1.2 | 1.8 | 0.60 |
| ΣR₂O (R = Na, K, Cs, Rb) | 0.05 | 0.35 | 0.7 | 0.50 |
| ΣRO (R = Ca, Ba, Sr) | 2.25 | 2.35 | | 1.85 |
| Va [° C.] | | | | |
| Ceram. temperature [° C.] | 770 | 810 | 790 | 830 |
| Ceram. time [days] | 5 | 1 | 5 | 2.5 |
| Cryst. phase [vol %] | 73 | 69 | 74 | 66 |
| Cryst. size [nm] | 43 | 47 | 56 | 41 |
| Av. CTE(0; +50° C.) [ppm/K] | −0.03 | −0.08 | −0.06 | 0.07 |
| TCL (0; +50° C.) | | | | 4.29 |
| \|Expansion at 50° C.\| | | | | 3.55 |
| Index F | | | | 1.21 |
| Hyst @ 45° C. [ppm] | <0.1 | <0.1 | <0.1 | <0.1 |
| Hyst @ 35° C. [ppm] | <0.1 | <0.1 | <0.1 | <0.1 |
| Hyst @ 30° C. [ppm] | <0.1 | <0.1 | <0.1 | <0.1 |
| Hyst @ 22° C. [ppm] | 0.13 | <0.1 | 0.16 | <0.1 |
| Hyst @ 19° C. [ppm] | 0.19 | <0.1 | | <0.1 |
| Hyst @ 15° C. [ppm] | 0.28 | 0.16 | | 0.11 |
| Hyst @ 10° C. [ppm] | 0.44 | 0.3 | 0.44 | 0.15 |
| Hyst @ +5° C. [ppm] | 0.67 | 0.55 | 0.63 | 0.23 |
| Hyst @ 0° C. [ppm] | 0.97 | 0.84 | 0.85 | 0.35 |
| Ceram. temperature [° C.] | | | | |
| Ceram. time [days] | | | | |
| Av. CTE (−30; +70° C.)[ppm/K] | | | | |
| Av. CTE (−40; +80° C.)[ppm/K] | | | | |

TABLE 3
Alternative index f_{T.i.} for selected Ex. and Comp. Ex.

| | | | |
|---|---|---|---|
| f_{T.i.} | Ti-dop. | | |
| [ppm/K] | SiO₂ | Ex. 2 | Ex. 4 |

| | | | | |
|---|---|---|---|---|
| 20-40° | C. | 0.024 | 0.020 | 0.019 |
| 20-70° | C. | 0.039 | 0.022 | |
| −10-30° | C. | 0.015 | | 0.005 |

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A lithium aluminum silicate (LAS) glass-ceramic having an average coefficient of thermal expansion (CTE) in a range from 0 to 50° C. of at most 0±0.1×10⁻⁶/K and a thermal hysteresis at least in a temperature range from 15° C. to 35° C. of <0.1 ppm and comprising components as follows (in mol % based on oxide):

| | |
|---|---|
| SiO₂ | 60-<70; |
| Li₂O | 7-9.6; |
| MgO + ZnO | >0.5-1.5; |
| R₂O | >0.5, where R₂O is Na₂O and/or |
| | K₂O and/or Cs₂O and/or Rb₂O; |

and
nucleating agent with a content of 1.5 to 6 mol %, wherein the nucleating agent is at least one component selected from the group consisting of TiO₂, ZrO₂, Ta₂O₅, Nb₂O₅, SnO₂, MoO₃, WO₃ and HfO₂.

2. The LAS glass-ceramic of claim 1, comprising Al₂O₃ with a content of 10 to 22 mol %.

3. The LAS glass-ceramic of claim 1, wherein the content of the sum total of ZnO+MgO is ≥0.55 mol % and/or <1.5 mol %.

4. The LAS glass-ceramic of claim 1, wherein the content of SiO₂ is ≤69.5 mol %.

5. The LAS glass-ceramic of claim 1, wherein a content of a sum total of RO (CaO+BaO+SrO) is ≥0.1 mol % and/or is ≤6 mol %.

6. The LAS glass-ceramic of claim 1, wherein the content of the sum total of R₂O (Na₂O+K₂O+Cs₂O+Rb₂O) is ≥0.55 mol % and/or is ≤6 mol %.

7. The LAS glass-ceramic of claim 1, wherein the nucleating agent comprises a plurality of components and a content of a sum total of the components is ≥2.5 mol % and/or is ≤5 mol %.

8. The LAS glass-ceramic of claim 1, wherein the following condition is applicable: molar content of SiO₂+(5×molar content of Li₂O)≥105; and/or
wherein the following condition is applicable: molar content of SiO₂+(5×molar content of Li₂O)≤115.5.

9. The LAS glass-ceramic of claim 1, wherein a processing temperature Va is not more than 1330° C.

10. The LAS glass-ceramic of claim 1, wherein a main crystal phase is high quartz solid solution.

11. The LAS glass-ceramic of claim 10, wherein an average crystallite size of the high quartz solid solution is <100 nm and/or a crystal phase fraction is less than 75 vol %.

12. The LAS glass-ceramic of claim 1, wherein an index F is <1.20, where F=TCL (0; 50° C.)|expansion (0; 50° C.)|, where TCL is a total change of length.

13. The LAS glass-ceramic of claim 1, wherein an alternative index f_{(20;40)} is <0.024 ppm/K and/or an alternative index f_{(20;70)} is <0.039 ppm/K and/or an alternative index f_{(-10;30)} is <0.015 ppm/K.

14. The LAS glass-ceramic of claim 1, having a relative change in length (dl/l₀) of ≤|0.10| ppm in a temperature range from 20° C. to 30° C. and/or a relative change in length (dl/l₀) of ≤|0.17| ppm in a temperature range from 20° C. to 35° C.

15. The LAS glass-ceramic of claim 1, having a relative change in length (dl/l₀) of ≤|0.30| ppm in a temperature range from 20° C. to 40° C.

16. The LAS glass-ceramic of claim 1, wherein a CTE-T curve in a temperature interval having a breadth of at least 30 K has a slope of ≤0±2.5 ppb/K².

17. The LAS glass-ceramic of claim 1, having a thermal hysteresis of <0.1 ppm at least in a temperature range from 15° C. to 40° C.

18. A precision component, comprising:
a lithium aluminum silicate (LAS) glass-ceramic having an average coefficient of thermal expansion CTE in a range from 0 to 50° C. of at most 0±0.1×10⁻⁶/K and a thermal hysteresis at least in a temperature range from 15° C. to 35° C. of <0.1 ppm and comprising components as follows (in mol % based on oxide):

| | |
|---|---|
| SiO₂ | 60-<70; |
| Li₂O | 7-9.6; |
| MgO + ZnO | >0.5-1.5; |
| R₂O | >0.5, where R₂O is Na₂O and/or |
| | K₂O and/or Cs₂O and/or Rb₂O; |

and
nucleating agent with a content of 1.5 to 6 mol %, where the nucleating agent is at least one component selected from the group consisting of TiO₂, ZrO₂, Ta₂O₅, Nb₂O₅, SnO₂, MoO₃, WO₃ and HfO₂.

19. The precision component of claim 18, wherein the LAS glass-ceramic comprises Al₂O₃ with a content of 10 to 22 mol %.

20. The precision component of claim 18, wherein the content of the sum total of ZnO+MgO is ≥0.55 mol % and/or <1.5 mol %.
